(19) United States
(12) Patent Application Publication
(10) Pub. No.: US 2025/0129487 A1
(43) Pub. Date: Apr. 24, 2025

(54) PRODUCTION METHOD FOR AMMONIA AND PRODUCTION DEVICE

(71) Applicant: NISSAN CHEMICAL CORPORATION, Tokyo (JP)

(72) Inventors: Shoichi KONDO, Funabashi-shi (JP); Norihito SHIGA, Funabashi-shi (JP); Masaaki OZAWA, Funabashi-shi (JP)

(73) Assignee: NISSAN CHEMICAL CORPORATION, Tokyo (JP)

(21) Appl. No.: 18/718,122

(22) PCT Filed: Dec. 12, 2022
(86) PCT No.: PCT/JP2022/045751

§ 371 Date: Dec. 31, 2024

(30) Foreign Application Priority Data
Dec. 10, 2021 (JP) 2021-201072
Dec. 10, 2021 (JP) 2021-201230

(51) Int. Cl. C25B 1/27

(52) U.S. Cl. CPC C25B 1/27

(57) ABSTRACT

An ammonia production method involves producing ammonia from nitrogen molecules, in a production device for performing electrolysis, in the presence of a metal complex and a solid catalyst in a cathode, by providing electrons from a power source, protons from a proton source, and nitrogen molecules from a means for supplying nitrogen gas, and by providing hydrogen molecules by sending hydrogen molecules to an anode including sending hydrogen gas produced at the cathode to the anode. Concerning a metal complex and a solid catalyst, as the metal complex, rac-ethylenebis(4,5,6,7-tetrahydro-1-indenyl) zirconium dichloride or the like is used, and as the solid catalyst, a metal catalyst or the like is used.

### TECHNICAL FIELD

The present invention relates to an ammonia production method and an ammonia production device.

### BACKGROUND ART

In a method for producing ammonia from nitrogen molecules by electrolysis in a low temperature range, there is a reported example in which ammonia was produced by electrolysis at 90° C. using a cathode in which ruthenium was supported on carbon felt and a platinum electrode as an anode (Non-Patent Document 1). There is a reported example in which ammonia was produced by electrolysis using Sm_{1.5}Sr_{0.5}CoO₄ or the like in an electrode in which ammonia was generated (Non-Patent Document 2).

### PRIOR ART DOCUMENTS

### Non-Patent Documents

Non-Patent Document 1: Chem. Commun. 2000, pp. 1673-1674
Non-Patent Document 2: Sci. Rep. 2013, vol. 3, pp. 1145-1151

### SUMMARY OF THE INVENTION

### Problem to be Solved by the Invention

In Non-Patent Document 1, since the operation was performed at around 90 to 100° C., there was a problem that the ammonia synthesis efficiency decreased at around 20 to 30° C. (i.e. room temperature). In Non-Patent Document 2, there was a problem that a process of treating a membrane with ammonia before the membrane used as an electrolyte film was incorporated into an electrolytic device was complicated.

The present invention has been made in order to solve the above problems and a main object of the present invention is to provide a novel method for electrochemically producing ammonia.

### Means for Solving the Problem

In order to achieve the above object, the inventors found that ammonia can be electrochemically produced using a newly designed ammonia production device using a membrane electrode assembly or a gas diffusion electrode, in which two catalyst layers disposed with an electrode catalyst are combined, with a function of a metal complex represented by a complex catalyst or the like and a function of a solid catalyst represented by a metal catalyst, a transition metal catalyst, a noble metal catalyst, an alloy catalyst, an oxide catalyst or the like, and completed the present invention.

Based on these findings, the present invention provides, for example, the following [1] to [10].

[1]

An ammonia production method using nitrogen molecules as a raw material, comprising:
in a production device that performs an electrolysis reaction, in the presence of a metal complex and a solid catalyst in a cathode,
providing electrons from a power source, protons from a proton source, and nitrogen molecules from a means for supplying nitrogen gas; and
providing hydrogen molecules from a means for supplying hydrogen gas at an anode.
   [2]

The ammonia production method according to [1],
wherein the means for supplying hydrogen gas at the anode includes a means for sending hydrogen gas produced at the cathode to the anode.
   [3]

The ammonia production method according to [1] or [2],
wherein the metal complex is a compound that is a nitrogen complex in which nitrogen molecules are coordinated to a metal in the center of the catalyst,
the solid catalyst is a metal catalyst, a transition metal catalyst, a noble metal catalyst, an alloy catalyst, an oxide catalyst, or a combination thereof, and
the proton source is at least one selected from the group consisting of an electrolyte film, an electrolytic solution, a catalyst layer, and an electrolyte in the catalyst layer.
   [4]

The ammonia production method according to any one of [1] to [3],
wherein the metal complex is a metallocene compound or a half-metallocene compound.
   [5]

The ammonia production method according to any one of [1] to [4],
wherein the metal complex is bis(cyclopentadienyl) titanium dichloride, bis(cyclopentadienyl) zirconium dichloride, rac-dimethylsilylbis(1-indenyl) zirconium dichloride, or rac-ethylenebis(4,5,6,7-tetrahydro-1-indenyl) zirconium dichloride.
   [6]

The ammonia production method according to any one of [1] to [5],
wherein the solid catalyst contains platinum, gold, palladium, or zinc oxide.
   [7]

An ammonia production device that produces ammonia from nitrogen molecules according to an electrolysis reaction and has a configuration including a cathode in which a cathode catalyst layer is bonded to one side of an electrolyte film and a cathode current collector is disposed on an outside of the cathode catalyst layer and an anode in which an anode catalyst layer is bonded to another side of the electrolyte film and an anode current collector is disposed on an outside of the anode catalyst layer, the cathode including the cathode catalyst layer and the cathode current collector, the anode including the anode catalyst layer and the anode current collector, the cathode including a cathode electrolytic solution tank with which a solid-liquid-gas is able to come into contact, and the anode including an anode electrolytic solution tank with which a solid-liquid-gas is able to come into contact, the device comprising:
a means for sending hydrogen gas to the anode;
a power source for supplying electrons to the cathode;
a proton source for supplying protons to the cathode; and
a means for supplying nitrogen gas to the cathode electrolytic solution tank, a cathode electrolytic solution, or the cathode.
   [8]

The ammonia production device according to [7],
wherein the means for sending hydrogen gas to the anode includes a means for sending hydrogen gas produced at the cathode to the anode.
   [9]

An ammonia production device that produces ammonia from nitrogen molecules according to an electrolysis reaction and has a configuration including a cathode in which a cathode catalyst layer is bonded to one side of an electrolyte film and a cathode current collector is disposed on an outside of the cathode catalyst layer and an anode in which an anode catalyst layer is bonded to another side of the electrolyte film and an anode current collector is disposed on an outside of the anode catalyst layer, the cathode including the cathode catalyst layer and the cathode current collector, the anode including the anode catalyst layer and the anode current collector, the cathode including a flow path with which a solid-liquid-gas is able to come into contact, and the anode including a flow path with which a solid-liquid-gas is able to come into contact, the device comprising:
a means for sending hydrogen gas to the anode;
a power source for supplying electrons to the cathode;
a proton source for supplying protons to the cathode; and
a means for supplying nitrogen gas to a cathode electrolytic solution tank, a cathode electrolytic solution, or the cathode.
   [10]

The ammonia production device according to [9],
wherein the means for sending hydrogen gas to the anode includes a means for sending hydrogen gas produced at the cathode to the anode.

### Effects of the Invention

According to the ammonia production method of the present invention, in a production device for performing electrolysis, in the presence of a metal complex and a solid catalyst in a cathode, by providing electrons from a power source, protons from a proton source, and nitrogen molecules from a means for supplying nitrogen gas, providing hydrogen molecules from a means for supplying hydrogen gas at an anode, and providing hydrogen molecules by a means for sending hydrogen gas produced at the cathode to the anode, it is possible to efficiently produce ammonia from nitrogen molecules. In addition, it is possible to reuse hydrogen gas produced at the cathode and provide an energy saving device that can produce ammonia.

### BRIEF DESCRIPTION OF THE DRAWINGS

FIG. 1 is a diagram illustrating an ammonia electrolytic device (Part 1).

FIG. 2 is a diagram illustrating the ammonia electrolytic device (Part 2).

FIG. 3 is a diagram illustrating the ammonia electrolytic device (Part 3).

FIG. 4 is a diagram illustrating the ammonia electrolytic device (Part 4).

FIG. 5 is a diagram illustrating the ammonia electrolytic device (Part 5).

FIG. 6 is a diagram illustrating a gas flow during operation of the ammonia electrolytic device (Part 3).

FIG. 7 is a diagram illustrating a gas flow during operation of the ammonia electrolytic device (Part 4).

### MODES FOR CARRYING OUT THE INVENTION

Preferable embodiments of an ammonia production method and an ammonia production device of the present invention will be described.

In this specification, “n” is an abbreviation for normal, “s” is an abbreviation for secondary, “t” is an abbreviation for tertiary, “o” is an abbreviation for ortho, “m” is an abbreviation for meta, “p” is an abbreviation for para, and “rac” is an abbreviation for racemic.

In this specification, the Cₐ to C_{b} alkyl group is a monovalent group formed by removing one hydrogen atom from a linear or branched aliphatic hydrocarbon group having a carbon atom number of a to b, and specific examples thereof include, for example, methyl group, ethyl group, n-propyl group, isopropyl group, n-butyl group, isobutyl group, s-butyl group, t-butyl group, n-pentyl group, isopentyl group, neopentyl group, t-pentyl group, 1,1-dimethylpropyl group, n-hexyl group, isohexyl group, 3-methylpentyl group, 2,2-dimethylbutyl group, 2,3-dimethylbutyl group, n-heptyl group, 2-methylhexyl group, 3-ethylpentyl group, n-octyl group, 2,2,4-trimethylpentyl group, 2,5-dimethylhexyl group, n-nonyl group, 2,7-dimethyloctyl group, and n-decyl group, and the number of carbon atoms is set within each of designated ranges. In “Cₐ to C_{b}” indicating the number of carbon atoms, a is an integer of 1 or more, and b is an integer of a or more.

The ammonia production method of the present embodiment can be performed using a production device for performing electrolysis. In this specification, the production device for performing electrolysis may be referred to as an electrolytic device, and is composed of an electrolysis cell, a nitrogen gas supply means, a hydrogen gas supply means, an ammonia recovery means, and an exhaust gas exclusion means, and the electrolytic device will be described below in detail.

The electrolysis cell is composed of an electrode, an electrolytic solution tank, a nitrogen gas supply port, a hydrogen gas supply port, and an exhaust gas outlet, and regarding the electrodes, an electrode in which an oxidation reaction occurs is an anode, and an electrode in which a reduction reaction occurs is a cathode.

The ammonia production method of the present embodiment is a method for producing ammonia from nitrogen molecules by providing, in the presence of a metal complex and a solid catalyst in a cathode, electrons from a power source, protons from a proton source disposed in an electrolytic device, and nitrogen molecules from a nitrogen gas supply means, and by providing hydrogen molecules from a means for supplying hydrogen gas at an anode, and regarding hydrogen gas, hydrogen molecules may be provided by a means for sending hydrogen gas produced in the cathode to the anode. In this method, as a catalyst for producing ammonia, a form of a combination of a metal complex and a solid catalyst in the cathode is used. In this specification, a catalyst in the form of a combination of a metal complex and a solid catalyst may be referred to as a catalyzer. When the environment in which the catalyzer is left is acidic, the proton source is preferably one that can supply at least one of protons and hydroxonium ions, when the environment in which the catalyzer is left is alkaline, the proton source is preferably one that can supply at least one of water and hydroxide ions, and these proton sources may be used alone or two or more thereof may be used in combination.

In the ammonia production method of the present embodiment, the metal complex may have a role of capturing nitrogen molecules when nitrogen molecules react near the electrode and then have a role of providing protons and electrons for reduction, and is not particularly limited as long as it is a compound in which nitrogen molecules are coordinated to the metal center of the metal complex. The compound is sometimes called a nitrogen complex.

Specifically, for the first time in 1965, [Ru(NH₃)₅N₂]²⁺ described in Non-Patent Document Chem. Commun., 1965, pp. 621-622, was found, and afterwards, in Non-Patent Documents Science, 1968, Vol. 159, pp. 320-322, J. Am. Chem. Soc., 1968, Vol. 90, pp. 3263-3264, J. Am. Chem. Soc., 1968, Vol. 90, pp. 5295-5296, Chem. Lett., 1993, Vol. 22, pp. 1329-1332, Polyhedron, 1996, Vol. 24, pp. 4421-4423, and Chem. Rev., 2004, Vol. 104, pp. 385-401, nitrogen complexes have been reported, and these can be exemplified as the nitrogen complexes.

More specifically, a molybdenum nitrogen complex having a triamide monoamine tetradentate ligand described in Non-Patent Document Science 2003, Vol. 301, pp. 76-78, an iron nitrogen complex having a triphosphine borane tetradentate ligand described in Non-Patent Document Nature 2013, Vol. 501, pp. 84-87, and a metallocene compound and a half-metallocene compound represented by bis(cyclopentadienyl)titanium dichloride described in U.S. Pat. No. 5,729,022 may be exemplified. The metallocene compound has a structure having two rings such as cyclopentadiene, benzene, cyclooctatetraene, and derivatives, and a metal atom interposed between the rings, and is sometimes called a sandwich compound. The half-metallocene compound has a structure having one of the rings and is sometimes called an open-sandwich compound.

Examples of metallocene compounds of the present embodiment include bis(cyclopentadienyl)titanium dichloride, μ-chloro- μ-methylene[bis(cyclopentadienyl)titanium]dimethylaluminum, bis(cyclopentadienyl)zirconium dichloride, bis(cyclopentadienyl)zirconium chloride hydride, bis(butylcyclopentadienyl)zirconium(IV) dichloride, decamethylzirconocene dichloride bis(pentamethylcyclopentadienyl)zirconium(IV) dichloride, 1,1′-isopropylidene zirconocene dichloride, hafnocene dichloride, 1,1′-dipropyl hafnocene dichloride bis(propylcyclopentadienyl)hafnium(IV) dichloride, and bis(cyclopentadienyl)vanadium dichloride, and examples of half-metallocene compounds include cyclopentadienyl titanium(IV) trichloride, (pentamethylcyclopentadienyl)titanium(IV) trichloride, (indenyl)titanium(IV) trichloride, trichloro(indenyl)titanium(IV), cyclopentadienylzirconium(IV) trichloride, dimethylsilylbis(1-indenyl)zirconium dichloride, rac-dimethylsilylbis(1-indenyl)zirconium dichloride, ethylenebis(4,5,6,7-tetrahydro-1-indenyl)zirconium dichloride, and rac-ethylenebis(4,5,6,7-tetrahydro-1-indenyl)zirconium dichloride. Among these, bis(cyclopentadienyl)titanium dichloride, bis(cyclopentadienyl)zirconium dichloride, rac-dimethylsilylbis(1-indenyl)zirconium dichloride, and rac-ethylenebis(4,5,6,7-tetrahydro-1-indenyl)zirconium dichloride are preferable.

In the ammonia production method of the present embodiment, regarding the metal complex, one having a form in which a metal complex is supported can also be used, and examples thereof include a complex of Formula (S2) obtained by radically polymerizing a complex of Formula (S1) having a vinyl group described in Non-Patent Document Journal of Organometallic Chemistry, Vol. 655, 2002, pp. 167-171 with styrene.

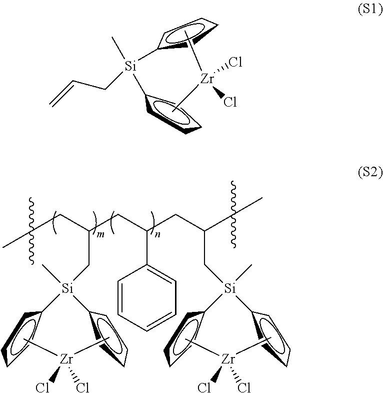

In addition, a form in which a metallocene compound is supported on a polymer is described in, for example, Non-Patent Document Comprehensive Organometallic Chemistry III (2007), pp. 728-738.

In the ammonia production method of the present embodiment, examples of solid catalysts include metal catalysts and oxide catalysts, and a combination of a plurality of these solid catalysts can also be used.

Examples of metal catalysts include metal catalysts that can be used as a single composition and a mixture of a plurality of metal components such as alloy catalysts, and metal nanoparticles formed using a surfactant, metal particles using a thiol compound and having self-assembled parts due to the bond between a metal and a thiol, metal nanoparticles, metal films, metal foils and the like can also be used.

As the thiol compound, for example, a compound of R¹—SH (R¹ has the same meaning as below) can be used. Here, R is not particularly limited and can be an appropriate group in consideration of the boiling point of R¹—SH, ease of isolation by chromatography and the like, and is preferably a C₁₋₂₀ organic group and more preferably a C₆₋₁₆ organic group. Examples of organic groups include hydrocarbon groups, chain saturated hydrocarbon groups, chain unsaturated hydrocarbon groups, cyclic saturated hydrocarbon groups, cyclic unsaturated hydrocarbon groups, aromatic hydrocarbon groups, those in which some of carbon-carbon bonds of these groups have intervening hetero atoms, and those substituted with a substituent containing a hetero atom.

Specific examples of thiol compounds include 2-methylbenzenethiol, 3-methylbenzenethiol, 4-methylbenzenethiol, phenylmethanethiol, 1-butanethiol, 1-decanethiol, 1-dodecanethiol, 1-heptanethiol, 1-hexadecanethiol, 1-hexanethiol, 1-nonanethiol, 1-octadecanethiol, 1-octanethiol, 1-pentadecanethiol, 1-pentanethiol, 1-propanethiol, 1-tetradecanethiol, 1-undecanethiol, 11-mercaptoundecyl trifluoroacetate, 1H,1H,2H,2H-perfluorodecanethiol, 2-ethylhexanethiol, 2-methyl-1-propanethiol, 2-methyl-2-propanethiol, 3-methyl-1-butanethiol, methyl 3-mercaptopropionate, tert-dodecyl mercaptan, (11-mercaptoundecyl)-N,N,N-trimethylammonium bromide, (11-mercaptoundecyl)hexa(ethylene glycol), (11-mercaptoundecyl)tetra(ethylene glycol), 1-(11-mercaptoundecyl)imidazole, 1-mercapto-2-propanol, 11-(1H-pyrrol-1-yl)undecane-1-thiol, 11-amino-1-undecanethiol hydrochloride, 11-mercapto-1-undecanol, 11-mercaptoundecanamide, 11-mercaptoundecanoic acid, 11-mercaptoundecylhydroquinone, 11-mercaptoundecylphosphonic acid, 12-mercaptododecanoic acid, 16-amino-1-hexadecanethiol hydrochloride, 16-mercaptohexadecanamide, 16-mercaptohexadecanoic acid, 3-amino-1-propanethiol hydrochloride, 3-chloro-1-propanethiol, 3-mercapto-1-propanol, 3-mercaptopropionic acid, 6-amino-1-hexanethiol hydrochloride, 6-mercapto-1-hexanol, 6-mercaptohexanoic acid, 8-amino-1-octanethiol hydrochloride, 8-mercapto-1-octanol, 8-mercapto-octanoic acid, 9-mercapto-1-nonanol, triethylene glycolmono-11-mercaptoundecyl ether, 1,4-butanediol diacetate, [11-(methylcarbonylthio)undecyl]hexa(ethylene glycol), [11-(methylcarbonylthio)undecyl]tetra(ethylene glycol), [11-(methylcarbonylthio)undecyl]tri(ethylene glycol)acetic acid, hexa(ethylene glycol)mono-11-(acetylthio)undecyl ether, S,S′-[1,4-phenylenebis(2,1-ethynediyl-4,1-phenylene)]bis(thioacetate), S-[4-[2-[4-(2-phenylethynyl)phenyl]ethynylphenyl]thioacetate, S-(10-undecyl)thioacetate, S-(11-bromoundecyl)thioacetate, S-(4-azidobutyl)thioacetate, S-(4-bromobutyl)thioacetate, S-(4-cyanobutyl)thioacetate, 1,1′,4′,1″-terphenyl-4-thiol, 1,4-benzene dimethanethiol, 1-adamantanethiol, 1-naphthalenethiol, 2-phenylethanethiol, 4′-bromo-4-mercaptophenyl, 4′-mercaptophenylcarbonitrile, 4,4′-bis(mercaptomethyl)biphenyl, 4,4′-dimercaptostilbene, 4-(6-mercaptohexyloxy)benzyl alcohol, 4-mercaptobenzoic acid, 9-fluorenyl methylthiol, 9-mercaptofluorene, biphenyl-4,4-dithiol, biphenyl-4-thiol, cyclohexanethiol, cyclopentanethiol, p-terphenyl-4,4″-dithiol, thiophenol, aminoethanethiol, aminopropanethiol, aminobutanethiol, methylaminoethanethiol, isopropylethylaminoethanethiol, dimethylaminoethanethiol, diethylaminoethanethiol, dibutylaminoethanethiol, mercaptoethylimidazole, mercaptopropylimidazole, mercaptobutylimidazole, mercaptohexylimidazole, mercaptotriazole, mercaptoethyltriazole, mercaptopropyltriazole, mercaptobutyltriazole, mercaptohexyltriazole, 3-mercaptopropylmethyldimethoxysilane, and 3-mercaptopropyltrimethoxysilane.

Examples of oxide catalysts include oxide catalysts that are used as metal oxides of typical elements, transition metal oxides, or a mixture of a plurality of metal oxides, and the metal oxides may be used as supports for solid catalysts.

In the ammonia production method of the present embodiment, examples of solid catalysts include metals such as iridium oxide(IV) powder catalysts, iridium oxide catalysts, platinum catalysts, gold catalysts, silver catalysts, ruthenium catalysts, iridium catalysts, rhodium catalysts, palladium catalysts, osmium catalysts, tungsten catalysts, lead catalysts, iron catalysts, chromium catalysts, cobalt catalysts, nickel catalysts, manganese catalysts, vanadium catalysts, molybdenum catalysts, gallium catalysts, aluminum catalysts and alloys thereof, aluminum oxide, zirconium oxide, titanium oxide, vanadium oxide, chromium oxide, manganese oxide, iron oxide, cobalt oxide, nickel oxide, copper oxide, zinc oxide, niobium pentoxide, molybdenum oxide, cerium oxide, samarium oxide, ruthenium oxide, rhodium oxide, silver oxide, tantalum oxide, tungsten oxide, osmium oxide, iridium oxide, indium oxide, platinum oxide, gold oxide, magnesium oxide, silica, silica-alumina, silica-magnesia, and combinations of the solid catalysts.

Examples of platinum catalysts, gold catalysts and silver catalysts include thiol-protected platinum nanoparticle catalysts, thiol-protected platinum catalysts, thiol-protected gold nanoparticle catalysts, thiol-protected gold catalysts, thiol-protected silver nanoparticle catalysts, and thiol-protected silver catalysts.

Among these, the solid catalyst used on the cathode side is defined as a cathode solid catalyst, and examples of preferable cathode solid catalysts include platinum catalysts, thiol-protected platinum nanoparticle catalysts, thiol-protected platinum catalysts, gold catalysts, thiol-protected gold nanoparticle catalysts, thiol-protected gold catalysts, iridium catalysts, palladium catalysts, zinc oxide, molybdenum oxide, cerium oxide, and samarium oxide, and more preferable examples thereof include platinum catalysts, thiol-protected platinum nanoparticle catalysts, gold catalysts, thiol-protected gold nanoparticle catalysts, thiol-protected gold catalysts, palladium catalysts, and zinc oxide. When a plurality of these solid catalysts is combined, a combination of a platinum catalyst and zinc oxide, a combination of a platinum catalyst and a gold catalyst, a combination of a platinum catalyst and a thiol-protected gold catalyst, a combination of a platinum catalyst and a palladium catalyst, a combination of a thiol-protected platinum nanoparticle catalyst and zinc oxide, a combination of a thiol-protected platinum nanoparticle catalyst and a gold catalyst, a combination of a thiol-protected platinum nanoparticle catalyst and a thiol-protected gold catalyst, and a combination of a thiol-protected platinum nanoparticle catalyst and a palladium catalyst are preferable.

In the ammonia production method of the present embodiment, the catalyzer on the cathode side, which is a catalyst in which a metal complex and a solid catalyst are combined, is defined as a cathode catalyzer, and examples of preferable combinations of the cathode catalyzers include a combination of bis(cyclopentadienyl)titanium dichloride and a platinum catalyst, a combination of bis(cyclopentadienyl)titanium dichloride and a thiol-protected platinum nanoparticle catalyst, a combination of bis(cyclopentadienyl)titanium dichloride and a palladium catalyst, a combination of bis(cyclopentadienyl)titanium dichloride and a gold catalyst, a combination of bis(cyclopentadienyl)titanium dichloride and a thiol-protected gold nanoparticle catalyst, a combination of bis(cyclopentadienyl)titanium dichloride and a thiol-protected gold catalyst, a combination of bis(cyclopentadienyl)titanium dichloride and zinc oxide, a combination of bis(cyclopentadienyl)titanium dichloride, a platinum catalyst and zinc oxide, a combination of bis(cyclopentadienyl)zirconium dichloride and a platinum catalyst, a combination of bis(cyclopentadienyl)zirconium dichloride and a thiol-protected platinum nanoparticle catalyst, a combination of bis(cyclopentadienyl)zirconium dichloride and a palladium catalyst, a combination of bis(cyclopentadienyl)zirconium dichloride and a gold catalyst, a combination of bis(cyclopentadienyl)zirconium dichloride and a thiol-protected gold nanoparticle catalyst, a combination of bis(cyclopentadienyl)zirconium dichloride and a thiol-protected gold catalyst, a combination of bis(cyclopentadienyl)zirconium dichloride and zinc oxide, a combination of bis(cyclopentadienyl)zirconium dichloride, a platinum catalyst and zinc oxide, a combination of rac-dimethylsilylbis(1-indenyl)zirconium dichloride and a platinum catalyst, a combination of rac-dimethylsilylbis(1-indenyl)zirconium dichloride and a thiol-protected platinum nanoparticle catalyst, a combination of rac-dimethylsilylbis(1-indenyl)zirconium dichloride and a palladium catalyst, a combination of rac-dimethylsilylbis(1-indenyl)zirconium dichloride and a gold catalyst, a combination of rac-dimethylsilylbis(1-indenyl)zirconium dichloride and a thiol-protected gold nanoparticle catalyst, a combination of rac-dimethylsilylbis(1-indenyl)zirconium dichloride and zinc oxide, a combination of rac-dimethylsilylbis(1-indenyl)zirconium dichloride, a platinum catalyst and zinc oxide, a combination of rac-ethylenebis(4,5,6,7-tetrahydro-1-indenyl)zirconium dichloride and a platinum catalyst, a combination of rac-ethylenebis(4,5,6,7-tetrahydro-1-indenyl)zirconium dichloride and a thiol-protected platinum nanoparticle catalyst, a combination of rac-ethylenebis(4,5,6,7-tetrahydro-1-indenyl)zirconium dichloride and a palladium catalyst, a combination of rac-ethylenebis(4,5,6,7-tetrahydro-1-indenyl)zirconium dichloride and a gold catalyst, a combination of rac-ethylenebis(4,5,6,7-tetrahydro-1-indenyl)zirconium dichloride and a thiol-protected gold nanoparticle catalyst, a combination of rac-ethylenebis(4,5,6,7-tetrahydro-1-indenyl)zirconium dichloride and zinc oxide, and a combination of rac-ethylenebis(4,5,6,7-tetrahydro-1-indenyl)zirconium dichloride, a platinum catalyst and zinc oxide, and examples of these combinations of metal complexes include combinations with those in which the metal complexes are supported.

A cathode catalyst layer 103 for producing ammonia of the present embodiment includes, in addition to a cathode catalyzer which is a catalyst in which a metal complex and a solid catalyst are combined, a catalyst support, an electron conductor, an electrolyte and a gas diffusion layer. Here, in this specification, the cathode catalyst layer 103 including a cathode catalyzer in which a metal complex and a cathode solid catalyst are combined, a catalyst support, an electron conductor, an electrolyte and a gas diffusion layer may be referred to as a gas diffusion electrode 133.

The catalyst support in the cathode catalyst layer 103 of the present embodiment may be responsible for electron conduction and is not particularly limited as long as it supports the catalyst of the present embodiment. Examples of catalyst supports include carbon black, carbon materials, metal meshes, metal foams, metal oxides, composite oxides, polymer electrolytes, ionic liquids, activated carbon, graphene oxides, reduced graphene oxides, carbon nitrides, and g-carbon nitride. In addition, when the catalyst support is used in an electrode, it has not only a role of supporting a catalyst but can also involve in the reaction occurring at the electrode as a catalyst or cocatalyst.

Examples of carbon black include channel black, furnace black, thermal black, acetylene black, ketjen black, and ketjen black EC, examples of carbon materials include activated carbon obtained by carbonizing and activating materials containing various carbon atoms, coke, natural graphite, artificial graphite, and graphitized carbon, examples metal meshes include nickel, tungsten, titanium, zirconium and hafnium metal meshes, examples of metal foams include metal foams of aluminum, magnesium, tungsten, titanium, zirconium, hafnium, zinc, iron, tin, lead and alloys containing these, examples of metal oxides include aluminum oxide, zirconium oxide, titanium oxide, vanadium oxide, chromium oxide, manganese oxide, iron oxide, cobalt oxide, nickel oxide, copper oxide, zinc oxide, niobium pentoxide, molybdenum oxide, ruthenium oxide, rhodium oxide, silver oxide, tantalum oxide, tungsten oxide, osmium oxide, iridium oxide, indium oxide, platinum oxide, gold oxide, magnesium oxide and silica, and examples of composite oxides include silica-alumina and silica-magnesia.

Examples of polymer electrolytes include fluorine-based polymer electrolytes, hydrocarbon-based polymer electrolytes, carboxyl group-containing acrylic copolymers, and carboxyl group-containing methacrylic copolymers.

Examples of fluorine-based polymer electrolytes include fluorine-based sulfonic acid polymers such as Nafion (registered trademark, commercially available from Du Pont Inc.), Aquivion (registered trademark, commercially available from Solvay S.A.), Flemion (registered trademark, commercially available from AGC Inc.), and Aciplex (registered trademark, commercially available from Asahi Kasei Corporation), hydrocarbon-based sulfonic acid polymers, partially fluorinated hydrocarbon-based sulfonic acid polymers, and anion-conducting electrolytes.

Examples of hydrocarbon-based polymer electrolytes include sulfonated polyether ketones, sulfonated polyether sulfones, sulfonated polyether ether sulfones, sulfonated polysulfides, and sulfonated polyphenylenes.

Specific examples of carboxyl group-containing acrylic copolymers include homopolymers or copolymers of acrylic acid, propiolic acid, crotonic acid, isocrotonic acid, myristoleic acid, palmitoleic acid, oleic acid, elaidic acid, vaccenic acid, gadoleic acid, eicosenoic acid, erucic acid, nervonic acid, ω-carboxy-polycaprolactone monoacrylate, phthalic acid monohydroxyethyl acrylate, acrylic acid dimer, 2-acryloyloxypropylhexahydrophthalic acid, 2-acryloyloxyethylsuccinic acid, maleic acid, fumaric acid, citraconic acid, mesaconic acid, atropaic acid, cinnamic acid, linoleic acid, eicosadienoic acid, docosadienoic acid, linolenic acid, pinolenic acid, eleostearic acid, mead acid, dihomo-Y-linolenic acid, eicosatrienoic acid, stearidonic acid, arachidonic acid, eicosatetraenoic acid, adrenic acid, bosseopentaenoic acid, eicosapentaenoic acid, osbond acid, sardine acid, tetracosapentaenoic acid, docosahexaenoic acid, nisinic acid, 2,2,2-trisacryloyloxymethylsuccinic acid, and 2-trisacryloyloxymethylethylphthalic acid, which have a carboxyl group and a copolymerizable double bond, acrylic acid alkyl esters such as methyl acrylate, ethyl acrylate, butyl acrylate, isobutyl acrylate, tert-butyl acrylate, hexyl acrylate, 2-ethylhexyl acrylate, octyl acrylate, nonyl acrylate, decyl acrylate, dodecyl acrylate, and stearyl acrylate, acrylamides such as diacetone acrylamide, acrylamide, 2-hydroxyethyl acrylamide, N-methylacrylamide, N-t-butylacrylamide, N-isopropyl acrylamide, N-phenyl acrylamide, N-methylol acrylamide, dimethylaminopropylacrylamide, dimethylaminopropylacrylamide, diacetone acrylamide, N,N-dimethylacrylamide, N-vinylformamide, acryloylmorpholine, and acryloylpiperidine, phosphonic acids such as [3-(acryloyloxy)propyl]phosphonic acid, and [3-(methacryloyloxy)propyl]phosphonic acid, vinyl alcohol esters such as acrylonitrile and vinyl-n-butyl ether, and copolymers to which a compound having a copolymerizable double bond is added such as acrylic acid tetrahydrofurfuryl ester, acrylic acid dimethylaminoethyl ester, acrylic acid diethylaminoethyl ester, acrylic acid glycidyl ester, 2,2,2-trifluoroethyl acrylate, 2,2,3,3-tetrafluoropropyl acrylate, styrene, and vinyltoluene. The homopolymerization or copolymerization can proceed by, for example, generating radicals using a radical polymerization initiator. Examples of radical polymerization initiators include azo compounds such as azobisisobutyronitrile, azobis(2-methylbutyronitrile), 2,2′-azobis-2,4-dimethylvaleronitrile, and 2,2′-azobis[N-(2-carboxyethyl)-2-methylpropionamidine methyl]tetrahydrate, organic peroxides such as t-butyl hydroperoxide, cumene hydroperoxide, benzoyl peroxide, dicumyl peroxide, and di-t-butyl peroxide, persulfates such as potassium persulfate, sodium persulfate, and ammonium persulfate, and hydrogen peroxide, and these can be used alone or two or more thereof can be used in combination.

Specific examples of carboxyl group-containing methacrylic copolymers include homopolymers or copolymers of methacrylic acid, ω-carboxy-polycaprolactone monomethacrylate, monohydroxyethyl phthalate methacrylate, methacrylic acid dimer, 2-methacryloyoxypropylhexahydrophthalic acid, and 2-methacryloyoxyethylsuccinic acid, which have a carboxyl group and a copolymerizable double bond, methacrylic acid alkyl esters such as methyl methacrylate, ethyl methacrylate, butyl methacrylate, isobutyl methacrylate, tert-butyl methacrylate, hexyl methacrylate, 2-ethylhexyl methacrylate, octyl methacrylate, nonyl methacrylate, decyl methacrylate, dodecyl methacrylate, and stearyl methacrylate, methacrylamides such as methacrylamide and dimethylaminopropylmethacrylamide, phosphonic acids such as α-phosphono-ω-(methacryloyloxy)poly(n=1 to 15)(oxypropylene), and copolymers to which a compound having a copolymerizable double bond is added such as methacrylic acid tetrahydrofurfuryl ester, methacrylic acid dimethylaminoethyl ester, methacrylic acid diethylaminoethyl ester, methacrylic acid glycidyl ester, 2,2,2-trifluoroethyl methacrylate, 2,2,3,3-tetrafluoropropyl methacrylate, styrene, and vinyltoluene. The homopolymerization or copolymerization can proceed by, for example, generating radicals using a radical polymerization initiator.

Examples of radical polymerization initiators include azo compounds such as azobisisobutyronitrile, azobis(2-methylbutyronitrile), 2,2′-azobis-2,4-dimethylvaleronitrile, and 2,2′-azobis[N-(2-carboxyethyl)-2-methylpropionamidine methyl]tetrahydrate, organic peroxides such as t-butyl hydroperoxide, cumene hydroperoxide, benzoyl peroxide, dicumyl peroxide, and di-t-butyl peroxide, persulfates such as potassium persulfate, sodium persulfate, and ammonium persulfate, and hydrogen peroxide, and these can be used alone or two or more thereof can be used in combination.

Examples of anion-conducting electrolytes include Fumion (registered trademark, commercially available from FUMATECH BWT GmbH) FAA-3-SOLUT-10, and A3ver. 2 and AS-4 (commercially available from Tokuyama Corporation) (A3 ver. 2 aand AS-4 are described in, for example, the Journal of “Hydrogen Energy Systems”, Vol. 35, No. 2, 2010, p. 9). When a positive ion exchange membrane (hereinafter referred to as a cation exchange membrane) is used as an electrolyte film to be described below, Nafion (registered trademark) and Aquivion (registered trademark) are preferable, and when a negative ion exchange membrane (hereinafter referred to as an anion exchange membrane) is used, FAA-3-SOLUT-10 and AS-4 are preferable.

As a polymer electrolyte, a combination of a plurality of these polymer electrolytes can also be used, and examples of polymer alloys as a mixture of two or more types of polymers include polymer blends in which two or more types of polymers are physically mixed, and interpenetrated polymer networks (IPN) in which network structures are intertwined.

Ionic liquids of the present embodiment will be described below. Examples of ionic liquids include imidazolium salts, pyridinium salts, ammonium salts, phosphonium salts, pyrrolidinium salts, piperidinium salts, and sulfonium salts.

Specific examples of imidazolium salts include those of Formula (1):

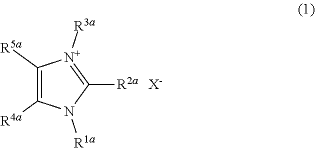

In Formula (1), R^{1a} to R^{5a} may be the same as or different from each other, and each may be, for example, a hydrogen atom, a C₁ to C₁₀ alkyl group, an allyl group, or a vinyl group. In addition, examples of X⁻ in Formula (1) include chlorine ions, bromine ions, iodine ions, tetrafluoroborate, trifluoro(trifluoromethyl)borate, dimethyl phosphate ions, diethyl phosphate ions, hexafluorophosphate, tris(pentafluoroethyl)trifluorophosphate, trifluoroacetate, methyl sulfate, trifluoromethanesulfonate, and bis(trifluoromethanesulfonyl)imide.

Specific examples of Formula (1) include, for example, salts of imidazolium ions such as 1-allyl-3-methylimidazolium ions, 3-ethyl-1-vinyl imidazolium ions, 1-methylimidazolium ions, 1-ethyl imidazolium ions, 1-n-propyl imidazolium ions, 1,3-dimethylimidazolium ions, 1,2,3-trimethylimidazolium ions, 1-ethyl-3-methylimidazolium ions, 1-ethyl-2,3-dimethylimidazolium ions, 1,2,3,4-tetramethylimidazolium ions, 1,3-diethylimidazolium ions, 1-methyl-3-n-propylimidazolium ions, 1-ethyl-3-methylimidazolium ions, 2-ethyl-1,3-dimethylimidazolium ions, 1-ethyl-2,3-dimethylimidazolium ions, 1,3-dimethyl-n-propylimidazolium ions, 1,3,4-trimethylimidazolium ions, 2-ethyl-1,3,4-trimethylimidazolium ions, 1,2-dimethyl-3-propyl imidazolium ions, 1-butyl-2,3-dimethylimidazolium ions, 1-butyl-3-methylimidazolium ions, 1-hexyl-3-methylimidazolium ions, and 1-methyl-3-n-octylimidazolium ions and X⁻ in Formula (1).

Specific examples of pyridinium salts include those of Formula (2):

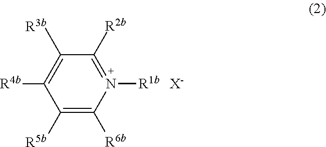

In Formula (2), R^{1b} to R^{6b} may be the same as or different from each other, and each may be, for example, a hydrogen atom, a hydroxymethyl group, or a C₁ to C₆ alkyl group. In addition, examples of X⁻ in Formula (2) include the same ones as in Formula (1).

Specific examples of Formula (2) include, for example, salts of pyridinium ions such as 1-butyl-3-methylpyridinium ions, 1-butyl-4-methylpyridinium ions, 1-butyl-pyridinium ions, 1-ethyl-3-methylpyridinium ions, 1-ethylpyridinium ions, and 1-ethyl-3-(hydroxymethyl)pyridinium ions and X⁻ in Formula (1).

Specific examples of ammonium salts include those of Formula (3):

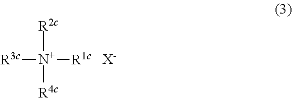

In Formula (3), R^{1c} to R^{4c} may be the same as or different from each other, and each may be, for example, a hydrogen atom, a methoxyethyl group, a phenylethyl group, a methoxypropyl group, a cyclohexyl group, or a C₁ to C₈ alkyl group. In addition, examples of X⁻ in Formula (3) include the same ones as in Formula (1).

Specific examples of Formula (3) include salts of ammonium ions such as triethylpentyl ammonium ions, diethyl(methyl)propyl ammonium ions, methyltri-n-octylammonium ions, trimethylpropylammonium ions, cyclohexyltrimethylammonium ions, diethyl(2-methoxyethyl)-methylammonium ions, ethyl(2-methoxyethyl)-dimethylammonium ions, ethyl(3-methoxypropyl)dimethyl-ammonium ions, and ethyl(dimethyl)(2-phenylethyl)-ammonium ion and X⁻ in Formula (1).

Specific examples of phosphonium salts include those of Formula (4):

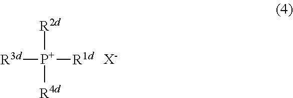

In Formula (4), R^{1d} to R^{4d} may be the same as or different from each other, and each may be, for example, a hydrogen atom, a methoxyethyl group, or a C₁ to C₁₀ alkyl group. In addition, examples of X⁻ in Formula (3) include the same ones as in Formula (1).

Specific examples of Formula (4) include salts of phosphonium ions such as tributylmethylphosphonium ions, tetrabutylphosphonium ions, trihexyl(tetradecyl)phosphonium ions, trihexyl(ethyl)phosphonium ions, and tributyl(2-methoxyethyl)-phosphonium ions and X⁻ in Formula (1).

Specific examples of pyrrolidinium salts include those of Formula (5):

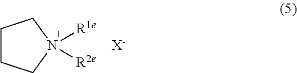

In Formula (5), R^{1e} to R^{2e} may be the same as or different from each other, and each may be, for example, a hydrogen atom, an allyl group, a methoxyethyl group, or a C₁ to C₈ alkyl group. In addition, examples of X⁻ in Formula (5) include the same ones as in Formula (1).

Specific examples of Formula (5) include salts of pyrrolidinium ions such as 1-allyl-1-methylpyrrolidinium ions, 1-(2-methoxyethyl)-1-methylpyrrolidinium ions, 1-butyl-1-methylpyrrolidinium ions, 1-methyl-1-propylpyrrolidinium ions, 1-octyl-1-methylpyrrolidinium ions, and 1-hexyl-1-methylpyrrolidinium ions and X⁻ in Formula (1).

Specific examples of piperidinium salts include those of Formula (6):

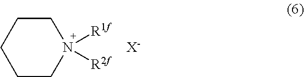

In Formula (6), R^{1f} to R^{2f} may be the same as or different from each other, and each may be, for example, a hydrogen atom or a C₁ to C₆ alkyl group. In addition, examples of X⁻ in Formula (6) include the same ones as in Formula (1).

Specific examples of Formula (6) include salts of piperidinium ions such as 1-butyl-1-methylpiperidinium ions and 1-methyl-1-propylpiperidinium ions and X⁻ in Formula (1).

Specific examples of sulfonium salts include those of Formula (7):

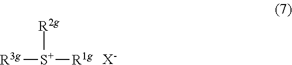

In Formula (7), R^{1g} to R^{3g} may be the same as or different from each other, and each may be, for example, a hydrogen atom or a C₁ to C₄ alkyl group. In addition, examples of X⁻ in Formula (3) include the same ones as in Formula (1).

Specific examples of Formula (4) include salts of sulfonium ions such as triethylsulfonium ions and trisulfonium ions and X⁻ in Formula (1).

More specific examples of ionic liquids include 1-allyl-3-methylimidazolium chloride, 1-butyl-3-methylimidazolium bromide, 1-butyl-3-methylimidazolium tetrafluoroborate, 1-butyl-3-methylimidazolium hexafluorophosphate, 1-butyl-3-methylimidazolium trifluoromethanesulfonate, 1-butyl-3-methylimidazolium bis(trifluoromethanesulfonyl)imide, 1-butyl-3-methylimidazolium iodide, 1-butyl-3-methylimidazolium tris(pentafluoroethyl) trifluorotrifluorophosphate, 1-butyl-3-methylimidazolium trifluoro(trifluoromethyl)borate, 1-butyl-2,3-dimethylimidazolium trifluoromethanesulfonate, 1-butyl-3-methylimidazolium trifluoroacetate, 1-butyl-2,3-dimethylimidazolium trifluoromethanesulfonate, 1-butyl-3-methylimidazolium methyl sulfate, 1,3-dimethylimidazolium dimethylphosphate, 2,3-dimethyl-1-propylimidazolium bis(trifluoromethanesulfonyl)imide, 1-decyl-3-methylimidazolium bis(trifluoromethanesulfonyl)imide, 1,3-dimethylimidazolium methyl sulfate, 1-decyl-3-methylimidazolium bromide, 1-decyl-3-methylimidazolium chloride, 1-decyl-3-methylimidazolium tetrafluoroborate, 1-ethyl-3-methylimidazolium trifluoromethanesulfonate, 1-ethyl-3-methylimidazolium tetrafluoroborate, 1-ethyl-3-methylimidazolium bis(trifluoromethanesulfonyl)imide, 1-ethyl-2,3-dimethylimidazolium bis(trifluoromethanesulfonyl)imide, 1-ethyl-3-methylimidazolium methanesulfonate, 1-ethyl-3-methylimidazolium trifluoro(trifluoromethyl)borate, 3-ethyl-1-vinyl imidazolium bis(trifluoromethanesulfonyl)imide, 1-ethyl-3-methylimidazolium trifluoroacetate, 1-ethyl-3-methylimidazolium methyl sulfate, 1-ethyl-3-methylimidazolium diethyl phosphate, 1-hexyl-3-methylimidazolium chloride, 1-hexyl-3-methylimidazolium hexafluorophosphate, 1-hexyl-3-methylimidazolium tetrafluoroborate, 1-hexyl-3-methylimidazolium trifluoromethanesulfonate, 1-hexyl-3-methylimidazolium bromide, 1-(2-hydroxyethyl)-3-methylimidazolium chloride, 1-hexyl-3-methylimidazolium bis(trifluoromethanesulfonyl)imide, 1-(2-hydroxyethyl)-3-methylimidazolium tetrafluoroborate, 1-hexyl-3-methylimidazolium iodide, 1-methyl-3-propylimidazolium iodide, 1-methyl-3-n-octyl imidazolium bromide, 1-methyl-3-n-octyl imidazolium chloride, 1-methyl-3-n-octyl imidazolium hexafluorophosphate, 1-methyl-3-n-octylimidazolium trifluoromethanesulfonate, 1-methyl-3-n-octyl imidazolium tetrafluoroborate, 1-methyl-3-propylimidazolium bromide, 1-methyl-3-propylimidazolium tetrafluoroborate, 1-methyl-3-pentylimidazolium bromide, 1-methyl-3-n-octyl imidazolium bis(trifluoromethanesulfonyl)imide, 1-methyl-3-propylimidazolium bis(trifluoromethanesulfonyl)imide, 1-butylpyridinium tetrafluoroborate, 1-butyl-4-methylpyridinium tetrafluoroborate, 1-butylpyridinium bis(trifluoromethanesulfonyl)imide, 1-butyl-4-methylpyridinium bis(trifluoromethanesulfonyl)imide, 1-ethyl-3-methylpyridinium ethyl sulfate, 1-ethyl-3-(hydroxymethyl)pyridinium ethyl sulfate, 1-ethyl-3-methylpyridinium bis(trifluoromethanesulfonyl)imide, triethylpentylammonium bis(trifluoromethanesulfonyl)imide, diethyl(methyl)propylammonium bis(fluorosulfonyl)imide, diethyl(2-methoxyethyl)methyl ammonium bis(fluorosulfonyl)imide, ethyl(2-methoxyethyl)dimethylammonium bis(fluorosulfonyl)imide, ethyl(2-methoxyethyl)dimethylammonium bis(trifluoromethanesulfonyl)imide, ethyl(3-methoxypropyl)dimethyl ammonium bis(trifluoromethanesulfonyl)imide, ethyl(dimethyl)(2-phenylethyl)ammonium bis(trifluoromethanesulfonyl)imide, methyltri-n-octyl ammonium bis(trifluoromethanesulfonyl)imide, tributylmethyl ammonium bis(trifluoromethanesulfonyl)imide, trimethylpropylammonium bis(trifluoromethanesulfonyl)imide, tributylmethylphosphonium bis(trifluoromethanesulfonyl)imide, 1-allyl-1-methylpyrrolidinium bis(trifluoromethanesulfonyl)imide, 1-butyl-1-methylpyrrolidinium bis(trifluoromethanesulfonyl)imide, 1-butyl-1-methylpyrrolidinium bis(fluorosulfonyl)imide, 1-butyl-1-methylpyrrolidinium trifluoromethanesulfonate, 1-methyl-1-propylpyrrolidinium bis(trifluoromethanesulfonyl)imide, 1-methyl-1-propylpyrrolidinium bis(fluorosulfonyl)imide, 1-(2-methoxyethyl)-1-methylpyrrolidinium bis(fluorosulfonyl)imide, 1-butyl-1-methylpiperidinium bis(trifluoromethanesulfonyl)imide, 1-methyl-1-propylpiperidinium bis(fluorosulfonyl)imide, triethylsulfonium bis(trifluoromethanesulfonyl)imide, and combinations of the ionic liquids.

Among these, carbon black, ketjen black, ketjen black EC, Nafion (registered trademark), 1-butyl-3-methylimidazolium bis(trifluoromethanesulfonyl)imide, 1-butyl-1-methylpyrrolidinium bis(fluorosulfonyl)imide, 1-butyl-1-methylpyrrolidinium bis(trifluoromethanesulfonyl)imide, and 1-butyl-3-methylimidazolium tris(pentafluoroethyl) trifluorotrifluorophosphate are preferable as the catalyst support of the present embodiment. These catalyst supports may be used alone or two or more thereof may be used in combination, and a combination of carbon black and zinc oxide, a combination of ketjen black EC and zinc oxide, a combination of carbon black and molybdenum oxide, a combination of ketjen black EC and molybdenum oxide, a combination of carbon black, zinc oxide and 1-butyl-3-methylimidazolium bis(trifluoromethanesulfonyl)imide, a combination of ketjen black EC, zinc oxide and 1-butyl-3-methylimidazolium bis(trifluoromethanesulfonyl)imide, a combination of carbon black, zinc oxide and 1-butyl-3-methylimidazolium tris(pentafluoroethyl) trifluorotrifluorophosphate, and a combination of ketjen black EC, zinc oxide and 1-butyl-3-methylimidazolium tris(pentafluoroethyl) trifluorotrifluorophosphate are preferable.

The electron conductor in the cathode catalyst layer 103 of the present embodiment is not particularly limited as long as it is responsible for electron conduction. Examples thereof include carbon black such as channel black, furnace black, thermal black, acetylene black, ketjen black, and ketjen black EC, carbon materials such as activated carbon obtained by carbonizing and activating materials containing various carbon atoms, coke, natural graphite, artificial graphite, and graphitized carbon, metal meshes of nickel, titanium or the like and metal foams.

Among these, carbon black, ketjen black, ketjen black EC, nickel metal meshes, titanium metal meshes and metal foams are preferable as the electron conductor of the present embodiment because they have a large specific surface area and excellent electron conductivity, and titanium metal meshes and metal foams are more preferable because they have better durability.

The electrolyte in the cathode catalyst layer 103 of the present embodiment is not particularly limited as long as it is responsible for ion conduction. Examples thereof include fluorine-based polymer electrolytes, hydrocarbon-based polymer electrolytes, and anion-conducting electrolytes. Examples of fluorine-based polymer electrolytes include fluorine-based sulfonic acid polymers such as Nafion (registered trademark, commercially available from Du Pont Inc.), Aquivion (registered trademark, commercially available from Solvay S.A.), Flemion (registered trademark, commercially available from AGC Inc.), and Aciplex (registered trademark, commercially available from Asahi Kasei Corporation), hydrocarbon-based sulfonic acid polymers, and partially fluorinated hydrocarbon-based sulfonic acid polymers. Examples of hydrocarbon-based polymer electrolytes include sulfonated polyether ketone, sulfonated polyether sulfone, sulfonated polyether ether sulfone, sulfonated polysulfide, and sulfonated polyphenylene. Examples of anion-conducting electrolytes include Fumion (registered trademark, commercially available from FUMATECH BWT GmbH) FAA-3-SOLUT-10, and A3 ver. 2 and AS-4 (commercially available from Tokuyama Corporation) (A3 ver. 2 and AS-4 are described in, for example, the Journal of “Hydrogen Energy Systems”, Vol. 35, No. 2, 2010, p. 9). When a positive ion exchange membrane (hereinafter referred to as a cation exchange membrane) is used as an electrolyte film to be described below, Nafion (registered trademark) and Aquivion (registered trademark) are preferable, and when a negative ion exchange membrane (hereinafter referred to as an anion exchange membrane) is used, FAA-3-SOLUT-10 and AS-4 are preferable.

Among these, as the electrolyte in the cathode catalyst layer 103 of the present embodiment, one that is responsible for proton conduction is preferable, and Nafion, Aquivion, Flemion, and Aciplex are preferable. A mixture of the electrolytes may be used, and it is preferable to include a perfluoro acid-based polymer such as Nafion.

The gas diffusion layer in the cathode catalyst layer 103 of the present embodiment is not particularly limited as long as it is responsible for electron conduction, gas diffusion, and electrolytic solution diffusion. Examples thereof include carbon paper, carbon felts, and carbon cloths. Here, in this specification, the cathode catalyst layer 103 including a catalyzer that is a metal complex, a cathode solid catalyst, or a metal complex and a cathode solid catalyst, and including a gas diffusion layer may be referred to as the gas diffusion electrode 133.

Examples of carbon paper include TGP-H-060, TGP-H-090, TGP-H-120, TGP-H-060H, TGP-H-090H, and TGP-H-120H (commercially available from Toray Industries, Inc.), EC-TP1-030T, EC-TP1-060T, EC-TP1-090T, and EC-TP1-120T (commercially available from ElectroChem, Inc.), and 22BB, 28BC, 36BB, and 39BB (commercially available from SIGRACET, SGL Carbon SE). Examples of carbon cloths include EC-CC1-060, EC-CC1-060T, and EC-CCC-060 (commercially available from ElectroChem, Inc.), and TORAYCA (registered trademark, commercially available from Toray Industries, Inc.) C06142, C06151B, C06343, C06343B, C06347B, C06644B, CO1302, CO1303, C05642, C07354, C07359B, CK6244C, CK6273C, and CK6261C cloths. Examples of carbon felts include H1410 and H2415 (commercially available from Freudenberg SE).

Among these, TGP-H-060, TGP-H-090, TGP-H-060H, TGP-H-090H, and EC-TP1-060T are preferable for the gas diffusion layer in the cathode catalyst layer 103 of the present embodiment.

In the ammonia production method of the present embodiment, examples of proton sources disposed in the electrolytic device include an electrolyte film 102 disposed next to the cathode catalyst layer 103, an electrolytic solution derived from the electrolyte film, and an electrolytic solution in an electrolytic solution tank disposed next to the cathode catalyst layer 103, and the electrolytic solution is not particularly limited as long as it is a solution containing an electrolyte and is responsible for proton conduction. These proton sources may be used alone or two or more thereof may be used in combination.

In the electrolytic solution in the ammonia production method of the present embodiment, examples of solutions include water, sulfuric acid aqueous solutions, ionic liquids, methanol, isopropyl alcohol, N,N-dimethylformamide, N,N-dimethylacetamide, dimethyl sulfoxide, N-methylpyrrolidone, diethylamine, hexamethylphosphonic acid triamide, acetic acid, acetonitrile, methylene chloride, trifluoroethanol, nitromethane, sulfolane, pyridine, tetrahydrofuran, dimethoxyethane, and propylene carbonate, and water, a sulfuric acid aqueous solution and an ionic liquid are preferable.

Examples of ionic liquids include those exemplified above such as imidazolium salts, pyridinium salts, ammonium salts, phosphonium salts, pyrrolidinium salts, piperidinium salts, and sulfonium salts.

Those obtained by adding acids such as sulfuric acid and trifluoromethanesulfonic acid to ionic liquids can be used, and preferable ionic liquids to which an acid is added include 1-butyl-3-methylimidazolium bis(trifluoromethanesulfonyl)imide, 1-butyl-1-methylpiperidinium bis(trifluoromethanesulfonyl)imide, and 1-butyl-3-methylimidazolium tris(pentafluoroethyl) trifluorotrifluorophosphate.

In the ammonia production method of the present embodiment, examples of electrolytes contained in the electrolytic solution include cations such as protons, lithium ions, sodium ions, potassium ions, imidazolium ions, pyridinium ions, quaternary ammonium ions, phosphonium ions, pyrrolidinium ions, and phosphonium ions alone or a plurality of combinations thereof, and anions such as chlorine ions, bromine ions, iodine ions, tetrafluoroborate, trifluoro(trifluoromethyl)borate, dimethyl phosphate ions, diethyl phosphate ions, hexafluorophosphate, tris(pentafluoroethyl)trifluorophosphate, trifluoroacetate, methyl sulfate, trifluoromethanesulfonate, bis(trifluoromethanesulfonyl)imide, perchlorate ions, sulfate ions, and nitrate ions alone or a plurality of combinations thereof. The electrolytes may be used alone or two or more thereof may be used in combination.

Examples of quaternary ammonium ions in the electrolyte include triethylpentyl ammonium ions, diethyl(methyl)propyl ammonium ions, methyltri-n-octylammonium ions, trimethylpropylammonium ions, cyclohexyltrimethylammonium ions, diethyl(2-methoxyethyl)-methylammonium ions, ethyl(2-methoxyethyl)-dimethylammonium ions, ethyl(3-methoxypropyl)dimethyl-ammonium ions, ethyl(dimethyl)(2-phenylethyl)-ammonium ions, tetramethylammonium ions, tetraethyl ammonium ions, triethylpentyl ammonium ions, tetra-n-butylammonium ions, diethyl(methyl)propyl ammonium ions, methyltri-n-octylammonium ions, trimethylpropylammonium ions, cyclohexyltrimethylammonium ions, diethyl(2-methoxyethyl)-methylammonium ions, ethyl(2-methoxyethyl)-dimethylammonium ions, ethyl(3-methoxypropyl)dimethyl-ammonium ions, and ethyl(dimethyl)(2-phenylethyl)-ammonium ions.

Specific examples of imidazolium ions, pyridinium ions, phosphonium ions, pyrrolidinium ions and phosphonium ions in the electrolyte include those exemplified above.

The cations that are the electrolytes contained in the electrolytic solution of the present embodiment are preferably protons, imidazolium ions or pyrrolidinium ions, and the anions that are the electrolytes are preferably perchlorate ions or sulfate ions.

Specific examples of a cathode electrolytic solution 106 used in a cathode electrolytic solution tank 105 of the present embodiment include water, sulfuric acid aqueous solutions, ionic liquids, ethylene carbonate, propylene carbonate, dimethyl carbonate, diethyl carbonate, ethyl methyl carbonate, methanol, ethanol, 1-propanol, 2-propanol, acetone, tetrahydrofuran, 1,2-dimethoxyethane, acetonitrile, pyridine, 1-butyl-1-methylpyrrolidinium bis(trifluoromethanesulfonyl)imide, and 1-butyl-3-methylimidazolium bis(trifluoromethanesulfonyl)imide, and these may be used alone or two or more thereof may be used in combination. The cathode electrolytic solution 106 is preferably water, sulfuric acid aqueous solutions, ionic liquids, 1-butyl-1-methylpyrrolidinium bis(trifluoromethanesulfonyl)imide, or 1-butyl-3-methylimidazolium bis(trifluoromethanesulfonyl)imide.

Specific examples of an anode electrolytic solution 116 used in an anode electrolytic solution tank 115 of the present embodiment include water, sulfuric acid aqueous solutions, ionic liquids, ethylene carbonate, propylene carbonate, dimethyl carbonate, diethyl carbonate, ethyl methyl carbonate, methanol, ethanol, 1-propanol, 2-propanol, acetone, tetrahydrofuran, 1,2-dimethoxyethane, acetonitrile, pyridine, 1-butyl-1-methylpyrrolidinium bis(trifluoromethanesulfonyl)imide, and 1-butyl-3-methylimidazolium bis(trifluoromethanesulfonyl)imide, and the anode electrolytic solution 116 is preferably water, sulfuric acid aqueous solutions, ionic liquids, 1-butyl-1-methylpyrrolidinium bis(trifluoromethanesulfonyl)imide, or 1-butyl-3-methylimidazolium bis(trifluoromethanesulfonyl)imide.

In the ammonia production method of the present embodiment, examples of the electrolyte film 102 include polymer electrolyte films and reinforcing membranes, and due to the difference in the fixed charged structure in one membrane, in addition to the cation exchange membrane and the anion exchange membrane, as a composite charged membrane in which cation exchange membrane and anion exchange membrane structures are present in one membrane, bipolar membranes and mosaic charged membranes may be exemplified, which can be arbitrarily selected and used in the ammonia production device of the present embodiment. Specific examples of such electrolyte films include Nafion membranes (registered trademark, commercially available from Du Pont Inc.), Aquivion membranes (registered trademark, commercially available from Solvay S.A.), Flemion membranes (registered trademark, commercially available from AGC Inc.), Aciplex (registered trademark, commercially available from Asahi Kasei Corporation), Dow membranes (registered trademark, commercially available from Dow Inc.), sulfonated polyether ketone polymer membranes, sulfonated polyether sulfone polymer membranes, sulfonated polyether ether sulfone polymer membranes, sulfonated polysulfide polymer membranes, sulfonated polyphenylene polymer membranes, Gore-Select membranes (registered trademark, commercially available from W. L. Gore & Associates, G.K.) impregnated with perfluorosulfonic acid polymers using porous polytetrafluoroethylene (PTFE) as a reinforcement material, membranes reinforced with PTFE woven fabrics and membranes using porous polyethylene (PE) or porous polypropylene (PP) as a reinforcement material (for example, described in Patent Document WO 98/20063), fibril reinforced membranes using PTFE fibrils (for example, described in Patent Document US 2001-026883A1, and Non-Patent Document Industrial Materials, 2001, Vol. 49, p. 31), NEOSEPTA (registered trademark, commercially available from ASTOM Corporation), Selemion membranes (registered trademark, commercially available from AGC Inc.), Aciplex membranes (registered trademark, commercially available from Asahi Kasei Corporation), Fumasep membranes (registered trademark, commercially available from FUMATECH BWT GmbH), and fumapem membranes (registered trademark, commercially available from FUMATECH BWT GmbH).

In the ammonia production method of the present embodiment, when the cation exchange membrane is used as the electrolyte film 102, Nafion membranes (registered trademark, commercially available from Du Pont Inc.), Aquivion membranes (registered trademark, commercially available from Solvay S.A.) and Gore-Select membranes (registered trademark, commercially available from W. L. Gore & Associates, G.K.) are preferable, and when the anion exchange membrane is used, FAP-450 membranes and FAA-3 membranes as Fumasep membranes (registered trademark, commercially available from FUMATECH BWT GmbH), and ASVN membranes and AHO membranes as Selemion membranes (registered trademark, commercially available from AGC Inc.) are preferable.

In the ammonia production method of the present embodiment, as the electrolyte film 102, Nafion membranes (registered trademark) and Aquivion membranes (registered trademark) as cation exchange membranes are more preferable.

In the ammonia production method of the present embodiment, the reaction temperature is preferably −40° C. to 200° C., more preferably −10° C. to 120° C., and still more preferably 0° C. to 100° C. The electrolytic device can be started up at room temperature. The reaction atmosphere may be a pressurized atmosphere obtained by installing a backpressure valve at a pipe through which nitrogen is supplied or a normal pressure atmosphere. The reaction time is not particularly limited, and may be generally set in a range of several tens of minutes to several tens of hours, and the reaction can be performed continuously, or can be stopped during progress, and for example, after the reaction is performed for several hours, the reaction can be stopped once and the reaction can be performed again.

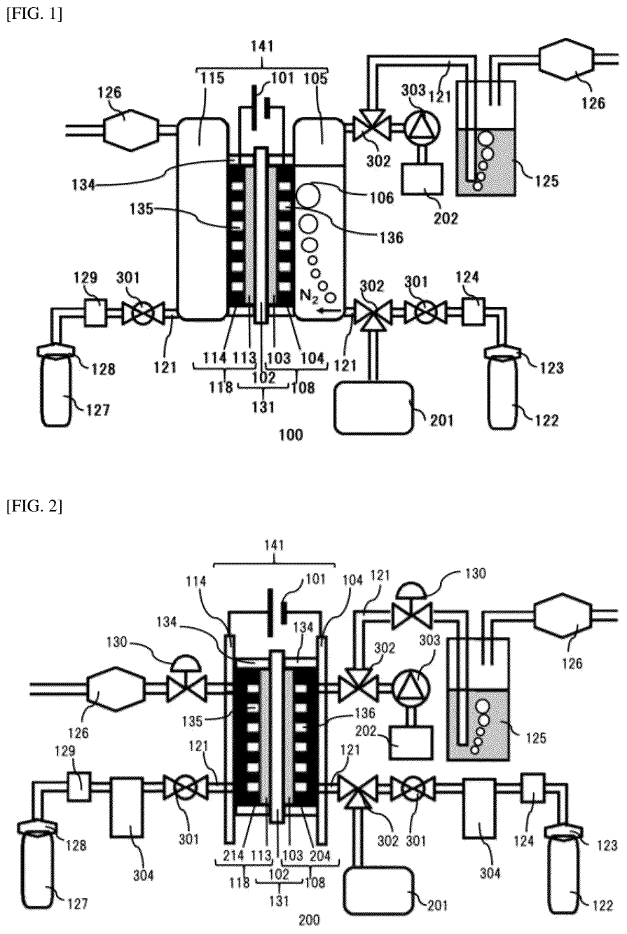

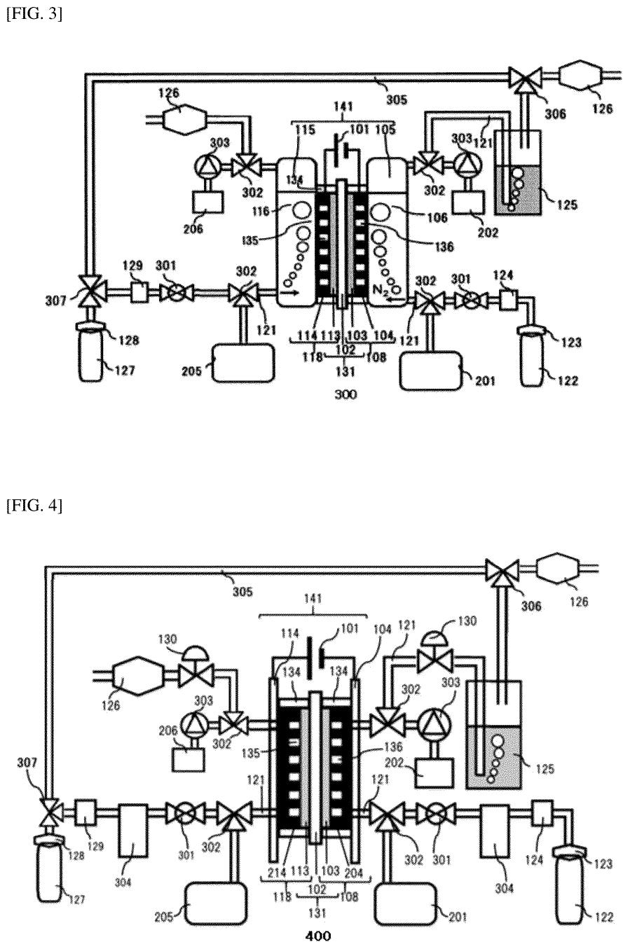

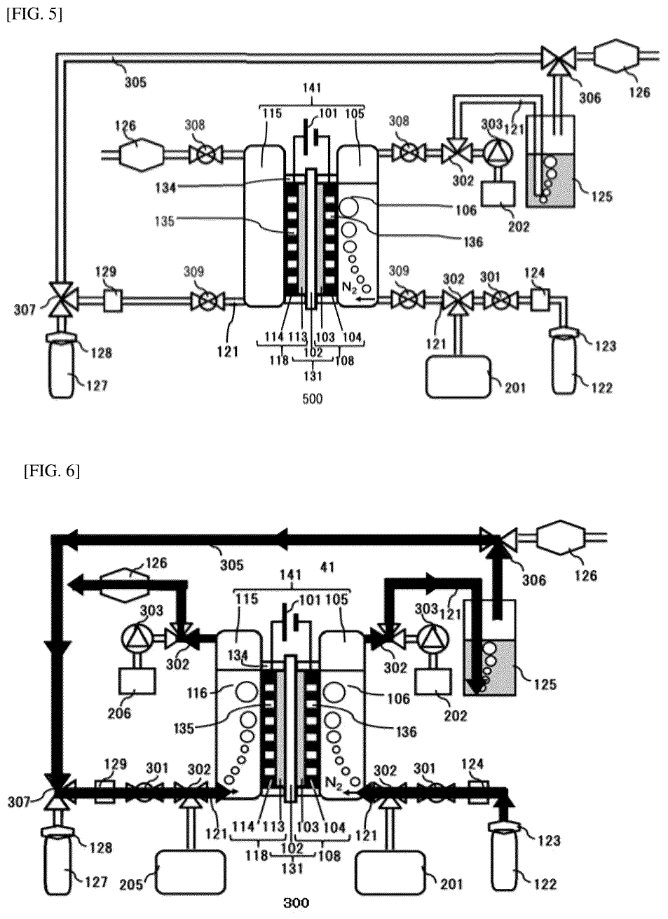

The ammonia production method and the electrolytic device which is the ammonia production device of the present embodiment will be described below. Here, as an example, FIG. 1 shows an ammonia electrolytic device (Part 1) 100 for producing ammonia, FIG. 2 shows an ammonia electrolytic device (Part 2) 200 for producing ammonia, FIG. 3 shows an ammonia electrolytic device (Part 3) 300 for producing ammonia, FIG. 4 shows an ammonia electrolytic device (Part 4) 400 for producing ammonia, and FIG. 5 shows an ammonia electrolytic device (Part 5) 500 for producing ammonia.

The ammonia electrolytic device (Part 1) 100 (FIG. 1) of the present embodiment is an ammonia production device that can produce ammonia from nitrogen molecules according to an electrolysis reaction, and includes a cathode 108 and an anode 118, and is ammonia production device including a membrane electrode assembly 131 in which the cathode catalyst layer 103 and an anode catalyst layer 113 are integrated with the electrolyte film 102 therebetween. The device has a configuration in which the cathode catalyst layer 103 is bonded to one side of the electrolyte film 102 and a cathode current collector 104 is disposed on the outside thereof, and the anode catalyst layer 113 is bonded to the other side of the electrolyte film 102 and an anode current collector 114 is disposed on the outside thereof. The current collector includes flow paths through which a gas, an electrolytic solution and a reaction solution flow. The reaction solution refers to a mixture of a solution produced according to an electrolysis reaction in the device, a gas and an electrolytic solution.

The cathode catalyst layer 103 includes a metal complex and a cathode solid catalyst, and the anode catalyst layer 113 includes an anode solid catalyst.

The production device (Part 1) 100 includes flow paths for a gas, an electrolytic solution and a reaction solution on the cathode side 136 that come into contact with the cathode 108 of the membrane electrode assembly 131 in a solid-liquid-gas state, and the cathode electrolytic solution tank 105 for storing the cathode electrolytic solution 106, and includes flow paths for a gas, an electrolytic solution and a reaction solution on the anode side 135 that come into contact with the anode 118 of the membrane electrode assembly 131 in a solid-liquid-gas state, and the anode electrolytic solution tank 115 for storing the anode electrolytic solution 116.

When hydrogen gas is supplied to the anode according to the present invention, it can be supplied from a hydrogen cylinder 127 via a hydrogen cylinder regulator 128 and a hydrogen gas mass-flow controller 129 and through a pipe 121, and when an electrolytic solution is not used, hydrogen gas supplied from the pipe 121 connected to the anode electrolytic solution tank 115 comes into contact with the anode 118 in a solid-gas state, and when an electrolytic solution is used, hydrogen gas supplied from the pipe 121 connected to the anode electrolytic solution tank 115 comes into contact with the anode 118 in a solid-liquid-gas state.

The production device includes a power source for supplying electrons to the cathode 108 (a power source device 101), a proton source for supplying protons to the cathode 108, a means for supplying nitrogen gas to the cathode electrolytic solution 106 and the cathode 108.

The proton source can serve as the electrolyte film 102, the cathode electrolytic solution 106, the cathode catalyst layer 103, the anode electrolytic solution 116, and the anode catalyst layer 113.

The means for supplying nitrogen gas is a means for supplying nitrogen gas from a nitrogen cylinder 122 via a nitrogen cylinder regulator 123 and a nitrogen gas mass-flow controller 124 and through the pipe 121, and when nitrogen gas is supplied, a three-way cock 302 is not connected to an electrolytic solution and reaction solution recovery tank 201.

A means for supplying hydrogen gas to the anode 118 is a means for supplying hydrogen gas from the hydrogen cylinder 127 via the hydrogen cylinder regulator 128 and the hydrogen gas mass-flow controller 129 and through the pipe 121, which can be implemented.

Ammonia produced at the cathode 108 can be collected in the cathode electrolytic solution tank 105 for storing the cathode electrolytic solution 106 and a dilute sulfuric acid aqueous solution tank for ammonia collection 125. The cathode electrolytic solution 106 can be recovered in the electrolytic solution and reaction solution recovery tank 201, and the next cathode electrolytic solution 106 can be transferred from a storage tank 202 to the cathode electrolytic solution tank 105 using a liquid transfer pump 303.

By-produced hydrogen and unreacted nitrogen pass through the pipe 121, pass through the dilute sulfuric acid aqueous solution tank for ammonia collection 125, and are discharged to the outside through a draft device 126.

A two-way cock 301 is shown at a typical position because it is shown as an example, but cocks for protecting a regulator, a mass-flow controller and the like which are instruments in the device can be attached to the pipes.

The ammonia electrolytic device (Part 3) 300 (FIG. 3) of the present embodiment is an ammonia production device that can produce ammonia from nitrogen molecules according to an electrolysis reaction, and is one in which a pipe 305, a three-way cock 307 and the three-way cock 307 are added to the ammonia electrolytic device (Part 1) 100.

Parts different from those in the ammonia electrolytic device (Part 1) 100 will be described.

When by-produced hydrogen gas at the cathode 108 is supplied to the anode 118 according to the present invention, if the dilute sulfuric acid aqueous solution tank for ammonia collection 125 and the pipe 305 are connected at a three-way cock 306 and the pipe 305 and the mass-flow controller 129 are connected at the three-way cock 307, a mixed gas (a mixed gas of nitrogen and hydrogen) that has passed through the dilute sulfuric acid aqueous solution tank for ammonia collection can be supplied to the anode electrolytic solution tank 115 and the anode 118, and hydrogen gas in the mixed gas comes into solid-gas contact with the anode 118. In this case, the anode electrolytic solution 116 can be used.

The anode electrolytic solution 116 can be recovered in an electrolytic solution and reaction solution recovery tank 205, and the next anode electrolytic solution 116 can be transferred from a storage tank 206 to the anode electrolytic solution tank 115 using the liquid transfer pump 303.

By-produced hydrogen and unreacted nitrogen pass through the pipe 121 and pass through the dilute sulfuric acid aqueous solution tank for ammonia collection 125, and can be discharged to the outside through the draft device 126 by the three-way cock 302, and can be sent to the anode 118 through the pipe 305 according to the present invention.

The two-way cock 301 is shown at a typical position because it is shown as an example, but cocks for protecting a regulator, a mass-flow controller and the like which are instruments in the device can be attached to the pipes.

The ammonia electrolytic device (Part 2) 200 of the present embodiment is an ammonia production device that can produce ammonia from nitrogen molecules according to an electrolysis reaction, and includes the cathode 108 and the anode 118, and is an ammonia production device including the membrane electrode assembly 131 in which the cathode catalyst layer 103 and the anode catalyst layer 113 are integrated with the electrolyte film 102 therebetween. The device has a configuration in which the cathode catalyst layer 103 is bonded to one side of the electrolyte film 102 and a separator 204 and the cathode current collector 104 on the cathode side are disposed on the outside thereof, and the anode catalyst layer 113 is bonded to the other side of the electrolyte film 102 and a separator 214 and the anode current collector 114 on the anode side are disposed on the outside thereof. The separator and the current collector include flow paths through which a gas, an electrolytic solution and a reaction solution pass. The reaction solution refers to a mixture of a solution produced according to an electrolysis reaction in the device, a gas and an electrolytic solution.

The cathode catalyst layer 103 includes a metal complex and a cathode solid catalyst, and the anode catalyst layer 113 includes an anode solid catalyst.

The production device (Part 2) 200 includes the flow paths for a gas, an electrolytic solution and a reaction solution on the cathode side 136 that come into contact with the cathode 108 of the membrane electrode assembly 131 in a solid-liquid-gas state, and includes the flow paths for a gas, an electrolytic solution and a reaction solution on the anode side 135 that come into contact with the anode 118 of the membrane electrode assembly 131 in a solid-liquid-gas state.

When hydrogen gas is supplied to the anode according to the present invention, it can be supplied from the hydrogen cylinder 127 via the hydrogen cylinder regulator 128, the hydrogen gas mass-flow controller 129 and a gas humidification device 304 and through the pipe 121. When the gas humidification device is set to non-humidification, hydrogen gas supplied from the pipe 121 connected to the flow paths for a gas, an electrolytic solution and a reaction solution on the anode side 135 comes into contact with the anode 118 in a solid-gas state, and when the gas humidification device is set to humidification, hydrogen gas supplied from the pipe 121 connected to the flow paths for a gas, an electrolytic solution and a reaction solution on the anode side 135 comes into contact with the anode 118 in a solid-liquid-gas state.

The production device includes the power source for supplying electrons to the cathode 108 (the power source device 101), a proton source for supplying protons to the cathode 108, and a means for supplying nitrogen gas to the cathode 108.

Examples of proton sources include the electrolyte film 102, the cathode electrolytic solution 106, the cathode catalyst layer 103, the anode electrolytic solution 116 and the anode catalyst layer 113.

The means for supplying nitrogen gas is a means for supplying nitrogen gas from the nitrogen cylinder 122 via the nitrogen cylinder regulator 123, the nitrogen gas mass-flow controller 124, the gas humidification device 304, the two-way cock 301 and the three-way cock 302 and through the pipe 121, and can also supply humidified nitrogen controlled using a relative humidity value. When nitrogen gas is supplied, the electrolytic solution and reaction solution recovery tank 201 is not connected to the three-way cock 302. The gas humidification device 304 can switch between non-humidification and humidification.

The means for supplying hydrogen gas to the anode 118 is a means for supplying hydrogen gas from the hydrogen cylinder 127 via the hydrogen cylinder regulator 128, the hydrogen gas mass-flow controller 129 and the gas humidification device 304 and through the pipe 121, and can also supply humidified hydrogen controlled using a relative humidity value.

Ammonia produced at the cathode 108 can be recovered in the dilute sulfuric acid aqueous solution tank for ammonia collection 125 and the electrolytic solution and reaction solution recovery tank 201. The electrolytic solution and the reaction solution can be transferred to the cathode 108 using the liquid transfer pump 303. By-produced hydrogen and unreacted nitrogen pass through the pipe 121, pass through the dilute sulfuric acid aqueous solution tank for ammonia collection 125, and are discharged to the outside through the draft device 126.

Cocks for protecting a regulator, a mass-flow controller and the like which are instruments in the device can be attached to the pipes.

The ammonia electrolytic device (Part 4) 400 (FIG. 4) of the present embodiment is an ammonia production device that can produce ammonia from nitrogen molecules according to an electrolysis reaction, and is one in which the pipe 305, the three-way cock 307 and the three-way cock 307 are added to the ammonia electrolytic device (Part 2) 200.

Parts different from those in the ammonia electrolytic device (Part 2) 200 will be described.

When by-produced hydrogen gas at the cathode 108 is supplied to the anode 118 according to the present invention, if the dilute sulfuric acid aqueous solution tank for ammonia collection 125 and the pipe 305 are connected at the three-way cock 306 and the pipe 305 and the mass-flow controller 129 are connected at the three-way cock 307, a mixed gas(a mixed gas of nitrogen and hydrogen) that has passed through the dilute sulfuric acid aqueous solution tank for ammonia collection can be supplied to the anode electrolytic solution tank 115 and the anode 118, and hydrogen gas in the mixed gas comes into solid-gas contact with the anode 118. In this case, the anode electrolytic solution 116 can be used.

The anode electrolytic solution 116 can be recovered in the electrolytic solution and reaction solution recovery tank 205, and the next anode electrolytic solution 116 can be transferred from the storage tank 206 to the flow paths for a gas, an electrolytic solution and a reaction solution on the anode side 135 using the liquid transfer pump 303, and can be sent to the recovery tank 205, and if the recovery tank 205 and the storage tank 206 are connected, the anode electrolytic solution 116 can be circulated using the liquid transfer pump 303.

The means for supplying hydrogen gas directly to the anode 118 is a means for supplying hydrogen gas from the hydrogen cylinder 127 via the hydrogen cylinder regulator 128, the hydrogen gas mass-flow controller 129, the gas humidification device 304, the two-way cock 301 and the three-way cock 302 and through the pipe 121, and can also supply humidified hydrogen controlled using a relative humidity value.

Ammonia produced at the cathode 108 can be recovered in the dilute sulfuric acid aqueous solution tank for ammonia collection 125 and the electrolytic solution and reaction solution recovery tank 201. The electrolytic solution and the reaction solution can be transferred to the cathode 108 using the liquid transfer pump 303.

By-produced hydrogen and unreacted nitrogen pass through the pipe 121, pass through the dilute sulfuric acid aqueous solution tank for ammonia collection 125, and can be discharged to the outside through the draft device 126 by the three-way cock 302, and can be sent to the anode 118 through the pipe 305 according to the present invention.

Cocks for protecting a regulator, a mass-flow controller and the like which are instruments in the device can be attached to the pipes.

When the reaction gas and the electrolytic solution are introduced into the flow paths on the anode side and the cathode side using the three-way cock 302 of the ammonia electrolytic device (Part 4) 400 (FIG. 4) according to the present embodiment and the cock is then closed, the cathode catalyst layer and the anode catalyst layer can each be pressurized with the reaction gas and the electrolytic solution, and the electrolysis reaction can be promoted.

The ammonia electrolytic device (Part 5) 500 (FIG. 5) of the present embodiment is an ammonia production device that can produce ammonia from nitrogen molecules according to an electrolysis reaction, and is a device in which two two-way cocks 308 and two two-way cocks 309 are added to the ammonia electrolytic device (Part 3) 300 (FIG. 3). When the two-way cock 308 is closed on the anode side and the cathode side, the reaction gas and the electrolytic solution are introduced, and the two-way cock 309 is then closed, the electrolytic solution tank and the cathode catalyst layer on the cathode side and the electrolytic solution tank and the anode catalyst layer on the anode side can each be pressurized with the reaction gas and the electrolytic solution, and the electrolysis reaction can be promoted.

For the cathode current collector 104 and the anode current collector 114 in the production device of the present embodiment, for example, carbon, metals, oxides, one whose surface is plated with a metal, alloys containing two or more types of metals, oxides containing two or more types of metals, stainless steel, indium tin oxide, and indium zinc oxide may be exemplified. Among these, examples of metals include titanium, vanadium, chromium, manganese, iron, cobalt, nickel, copper, zinc, niobium, molybdenum, ruthenium, rhodium, silver, tantalum, tungsten, osmium, iridium, indium, platinum, and gold, and examples of oxides include titanium oxide, vanadium oxide, chromium oxide, manganese oxide, iron oxide, cobalt oxide, nickel oxide, copper oxide, zinc oxide, niobium pentoxide, molybdenum oxide, ruthenium oxide, rhodium oxide, silver oxide, tantalum oxide, tungsten oxide, osmium oxide, iridium oxide, indium oxide, platinum oxide, and gold oxide.

The shape of the current collector is not particularly limited as long as it allows a gas or an electrolytic solution to pass through, and examples thereof include a perforated shape, a linear shape, a rod shape, a plate shape, a foil shape, a net shape, a woven fabric shape, a non-woven fabric shape, an expanded shape, a porous shape, and a foam shape. In order to prevent corrosion during production by electrolysis, a current collector plated with gold or the like can also be used.

In the electrolytic device of the present embodiment, nitrogen gas is supplied from the nitrogen cylinder 122 through the nitrogen cylinder regulator 123, the nitrogen gas mass-flow controller 124 and the gas humidification device 304, and humidified nitrogen controlled using a relative humidity value can be supplied with a controlled flow rate.

For example, a method for supplying nitrogen gas by bubbling it into the cathode electrolytic solution tank 105 in FIG. 1, FIG. 3 and FIG. 5 and the electrolytic solution in the anode electrolytic solution tank 115 in FIG. 2 and FIG. 4 can also be used, and as shown in FIG. 2 and FIG. 4, nitrogen gas can be supplied directly to the cathode catalyst layer 103 through holes in the cathode current collector 104. In the electrolytic device (Part 2) 200 and the electrolytic device (Part 4) 400, humidified nitrogen gas with a set relative humidity can also be supplied.

In the electrolytic device of the present embodiment, an electrolysis reaction in which ammonia is produced in the cathode catalyst layer 103 will be described. The catalyzer of the present embodiment causes a reaction in which ammonia is produced from three: electrons supplied from the power source device 101, nitrogen gas supplied to the cathode 108, and a proton source supplied to the cathode 108, and the reaction formula can be formally shown as “N₂+6e⁻+6H⁺→2NH₃” or “N₂+6e⁻+6H₃O⁺→2NH₃+6H₂O” when the environment in which the catalyzer is left is acidic, and “N₂+6e⁻+6H₂O→2NH₃+6OH” when the environment in which the catalyzer is left is alkaline.

While ammonia is produced in the cathode catalyst layer 103, hydroxonium ions or water and electrons can also react in the cathode catalyst layer, and thus hydrogen is produced as a by-product. This by-produced hydrogen can have a form of dissociation on the solid catalyst or on the catalyst support, and for example, Non-Patent Document Shriver and Atkins' Inorganic Chemistry (Volume 1) 6^{th} Edition (2016, translated Japanese version) p. 358 describes that, on a platinum catalyst as a metal catalyst, the adsorbed hydrogen is evenly dissociated into hydrogen atoms, and on zinc oxide as a metal oxide, the adsorbed hydrogen is unevenly dissociated into protons and hydrides. It is speculated that activated hydrogen atoms, protons and hydrides on the solid catalyst promote the reaction in which ammonia is produced.

Ammonia produced at the cathode 108 can also be sent to the dilute sulfuric acid aqueous solution tank for ammonia collection 125 together with by-produced hydrogen and unreacted nitrogen, and can be collected in the electrolytic solution used in the cathode electrolytic solution tank 105 in the electrolytic device (Part 1) 100 and the electrolytic device (Part 3) 300. In this case, in consideration of recovery and reuse, the electrolytic solution used in the cathode electrolytic solution tank 105 is preferably water or a dilute sulfuric acid aqueous solution, and it is possible to improve the efficiency of ammonia collection by circulating the electrolytic solution in the cathode electrolytic solution tank 105 with a pump, and for example, if the recovery tank 201 and the storage tank 202 are connected, the cathode electrolytic solution 106 and the cathode reaction solution can be circulated using the liquid transfer pump 303.

From the mixed gas composed of ammonia produced in the cathode catalyst layer 103 in the electrolytic device of the present embodiment, by-produced hydrogen and unreacted nitrogen, as described above, ammonia can be selectively collected using water or a dilute sulfuric acid aqueous solution, and thus it is also possible to simultaneously extract a mixed gas of by-produced hydrogen and nitrogen, and hydrogen, which is useful as an energy carrier, can also be obtained in the present embodiment. In addition, for safety, by-produced hydrogen can also be discharged to the outside through the draft device 126. As in the present invention, when hydrogen molecules are provided by a means for sending hydrogen gas produced at the cathode to the anode, ammonia can be efficiently produced from nitrogen molecules.

It is also possible to prevent gas leakage or liquid leakage at the connection part with the gas pipe or the electrolytic solution tank using a putty, a sealing agent or the like.

The electrolysis reaction in the anode catalyst layer 113 in the electrolytic device of the present embodiment will be described. The catalyst of the anode 118 causes a reaction in which electrons and protons are produced from the supplied hydrogen, and the reaction formula can be shown as “H₂→2e⁻+2H⁺”. The produced protons pass through the electrolyte film 102 or the electrolytic solution and move to the cathode 108, and electrons pass through the anode current collector 114 and move to the power source device 101. In this electrolytic device, electrons and protons can be supplied by paying attention to a hydrogen concentration and an oxygen concentration, stopping supply of hydrogen, and supplying water to the anode catalyst layer 113, and in this case, a reaction in which oxygen, electrons and protons are produced from water occurs, and the reaction formula can be shown as “2H₂O→O₂+4e⁻+4H⁺”. The produced protons pass through the electrolyte film 102 or the electrolytic solution and move to the cathode 108, and electrons pass through the anode current collector 114 and move to the power source device 101.

The generated oxygen that is partially dissolved in water in the anode electrolytic solution tank 115 can be released to the atmosphere, oxygen can be forcibly expelled by bubbling nitrogen gas into the anode electrolytic solution tank 115, and hydrogen can be supplied again.

When water is supplied to the anode catalyst layer 113, the generated oxygen that is partially dissolved in water in the anode electrolytic solution tank 115 or the flow paths for a gas, an electrolytic solution and a reaction solution on the anode side can be released to the atmosphere, supply of water to the anode catalyst layer 113 can be stopped and hydrogen can be supplied again. In the electrolytic device (Part 3) 300 and the electrolytic device (Part 4) 400, it is possible to selectively use hydrogen gas in the hydrogen cylinder 127 and the by-produced hydrogen gas at the cathode 108.

The anode catalyst layer 113 in the electrolytic device of the present embodiment includes a catalyst support, an electrolyte and a gas diffusion layer in addition to the solid catalyst. Here, in this specification, the anode catalyst layer 113 including an anode solid catalyst, a catalyst support, an electron conductor, an electrolyte and a gas diffusion layer may be referred to as the gas diffusion electrode 133.

It is defined as an anode solid catalyst which is a solid catalyst in the anode catalyst layer 113 of the electrolytic device of the present embodiment. Examples of anode solid catalysts include the same ones as those described for the solid catalyst and the cathode solid catalyst in the ammonia production method of the present embodiment, and specific examples include, for example, metals such as iridium oxide(IV) powder catalysts, iridium oxide catalysts, platinum catalysts, gold catalysts, silver catalysts, ruthenium catalysts, iridium catalysts, rhodium catalysts, palladium catalysts, osmium catalysts, tungsten catalysts, lead catalysts, iron catalysts, chromium catalysts, cobalt catalysts, nickel catalysts, manganese catalysts, vanadium catalysts, molybdenum catalysts, gallium catalysts, and aluminum catalysts and alloys thereof. Among these, the anode solid catalyst is preferably an iridium oxide(IV) powder catalyst, an iridium oxide catalyst, or a platinum catalyst. In addition, in order to efficiently perform the electrolysis reaction both when water is supplied to the anode catalyst layer 113 and when hydrogen gas is supplied to the anode catalyst layer 113, a combination of an iridium oxide catalyst and a platinum catalyst and a combination of an iridium oxide(IV) powder catalyst and a platinum catalyst can also be used.

The catalyst support in the anode catalyst layer 113 of the present embodiment may be responsible for electron conduction and is not particularly limited as long as it supports the catalyst of the present embodiment. Examples of catalyst supports include carbon black, carbon materials, metal meshes, metal foams, metal oxides, and composite oxides.

Examples of carbon black include channel black, furnace black, thermal black, acetylene black, ketjen black, and ketjen black EC, examples of carbon materials include activated carbon obtained by carbonizing and activating materials containing various carbon atoms, coke, natural graphite, artificial graphite, and graphitized carbon, examples of metal meshes include nickel and titanium metal meshes, examples of metal foams include metal foams of aluminum, magnesium, titanium, zinc, iron, tin, lead and alloys containing these, examples of metal oxides include aluminum oxide, zirconium oxide, titanium oxide, vanadium oxide, chromium oxide, manganese oxide, iron oxide, cobalt oxide, nickel oxide, copper oxide, zinc oxide, niobium pentoxide, molybdenum oxide, ruthenium oxide, rhodium oxide, silver oxide, tantalum oxide, tungsten oxide, osmium oxide, iridium oxide, indium oxide, platinum oxide, gold oxide, magnesium oxide and silica, and examples of composite oxides include silica-alumina and silica-magnesia. Among these, as the catalyst support, carbon black, ketjen black, ketjen black EC, nickel metal meshes, titanium metal meshes, titanium oxide and metal foams are preferable because they have a large specific surface area and excellent electron conductivity, and titanium metal meshes, titanium oxide and metal foams are more preferable because they have better durability.

The electrolyte in the anode catalyst layer 113 of the present embodiment is not particularly limited as long as it is responsible for ion conduction. The same ones as described in the electrolyte in the cathode catalyst layer 103 of the present embodiment may be exemplified, and as a specific example, when a cation exchange membrane is used as the electrolyte film, examples thereof include fluorine-based sulfonic acid polymers such as Nafion (registered trademark, commercially available from Du Pont Inc.), Aquivion (registered trademark, commercially available from Solvay S.A.), Flemion (registered trademark, commercially available from AGC Inc.), and Aciplex (registered trademark, commercially available from Asahi Kasei Corporation), hydrocarbon-based sulfonic acid polymers, and partially fluorinated hydrocarbon-based sulfonic acid polymers. Among these, as the electrolyte, one that is responsible for proton conduction is preferable, and Nafion, Aquivion, Flemion, and Aciplex are preferable. A mixture of the electrolytes may be used, and it is preferable to include a perfluoro acid-based polymer such as Nafion. When an anion exchange membrane is used as the electrolyte film, one that is responsible for conduction of hydroxide ions is preferable, and FAA-3-SOLUT-10 and AS-4 are preferable.

The gas diffusion layer in the anode catalyst layer 113 of the present embodiment is not particularly limited as long as it is responsible for electron conduction, gas diffusion, and electrolytic solution diffusion. The same ones as those described for the gas diffusion layer in the cathode catalyst layer 103 of the present embodiment may be exemplified and carbon paper is preferable, and specific examples thereof include, for example, TGP-H-060, TGP-H-090, TGP-H-120, TGP-H-060H, TGP-H-090H, and TGP-H-120H (commercially available from Toray Industries, Inc.), EC-TP1-030T, EC-TP1-060T, EC-TP1-090T, and EC-TP1-120T (commercially available from ElectroChem, Inc.), and 22BB, 28BC, 36BB, and 39BB (commercially available from SIGRACET, SGL Carbon SE). Among these, TGP-H-060, TGP-H-090, TGP-H-060H, TGP-H-090H, and EC-TP1-060T are preferable for the gas diffusion layer.

Here, the present invention is not limited to the above embodiments, and can be implemented in various forms within the technical scope of the present invention.

### EXAMPLES

Hereinafter, examples of the present invention will be described. Here, the following examples do not limit the present invention.

### Example 1

### 1. Preparation of Electrolytic Device for Ammonia Production

The cathode catalyst layer 103, which is a catalyst layer for producing ammonia, was prepared as follows. A catalyst ink 1A used for the cathode 108 was an ink for applying the cathode solid catalyst of the present embodiment to the cathode catalyst layer 103. The catalyst ink 1A was prepared using a platinum catalyst supported on carbon black (platinum content: 46.6 wt %, product name “TEC10E50E”, commercially available from Tanaka Kikinzoku Kogyo K.K.) as a solid catalyst, deionized water, ethanol and a Nafion dispersion solution (product name “5% Nafion dispersion solution DE520 CS type”, commercially available from FUJIFILM Wako Pure Chemical Corporation) as an electrolyte. Hereinafter, the platinum catalyst supported on carbon black may be abbreviated as a carbon-supported platinum catalyst. The carbon-supported platinum catalyst, deionized water, ethanol and the Nafion dispersion solution were added in that order to a glass vial bottle, and the obtained dispersion solution was irradiated with ultrasonic waves using an ultrasonic homogenizer Smurt NR-50M (commercially available from Microtec Co., Ltd.) with an output set to 40% for 30 minutes to prepare the catalyst ink 1A. Next, the catalyst ink 1A was applied to carbon paper (product name “TGP-H-060H”, commercially available from Toray Industries, Inc.) fixed on a hot plate set to 80° C., and ethanol and water were dried. The applied amount was adjusted so that the amount of platinum per 1 cm² was 1.0 mg. In this manner, the gas diffusion electrode 133 (gas diffusion electrode, hereinafter may be abbreviated as “GDE”) containing Nafion as an electrolyte and a carbon-supported platinum catalyst as a solid catalyst was prepared. Specifically, the gas diffusion electrode 133 was a 2.8×2.8 cm² square gas diffusion electrode 133 to which a platinum catalyst (7.8 mg) was applied as a solid catalyst, which is referred to as “GDE-Cathode-1A”.

Next, a catalyst ink 1B for applying the metal complex of the present embodiment to the cathode catalyst layer 103 was prepared. A solution in which rac-dimethylsilylbis(1-indenyl)zirconium dichloride (7.1 mg, 16 μmol) as a metal complex was dissolved in 1-butyl-3-methylimidazolium bis(trifluoromethanesulfonyl)imide (2.4 mL) was used as the catalyst ink 1B. The catalyst ink 1B (20 μL) was applied to “GDE-Cathode-1A” of the gas diffusion electrode 133 to prepare the cathode catalyst layer 103. Specifically, the gas diffusion electrode 133, which is the cathode catalyst layer 103, was a 2.8×2.8 cm² square gas diffusion electrode 133 to which a platinum catalyst (7.8 mg) as a solid catalyst and rac-dimethylsilylbis(1-indenyl)zirconium dichloride (0.13 μmol) were applied, which is referred to as “GDE-Cathode-1”.

The proportion of Nafion (hereinafter abbreviated as an ionomer) in the catalyst ink 1A will be described. The catalyst ink 1A was prepared such that the proportion of ionomer (wt %) calculated from the following formula was 28 wt %.

Proportion of ionomer (wt %)=[solid content of ionomer (weight)/[{carbon-supported platinum catalyst (weight)+solid content of ionomer (weight)}]×100

Specifically, when the ionomer was Nafion, the amount of the carbon-supported platinum catalyst was set to 100.0 mg, the amount of the Nafion dispersion solution was set to 837 μL, the amount of deionized water was set to 0.6 mL, and the amount of ethanol was set to 5 mL. The Nafion solid content in the Nafion dispersion solution (837 μL) was 38.9 mg.

The anode catalyst layer 113 was prepared as follows. The catalyst ink 1A described for the cathode catalyst layer 103 was prepared by the same method and applied by the same method to prepare the gas diffusion electrode 133, which is the anode catalyst layer 113 containing Nafion as an electrolyte and a carbon-supported platinum catalyst as a solid catalyst. Specifically, the gas diffusion electrode 133, which is the anode catalyst layer 113, was a 2.8×2.8 cm² square gas diffusion electrode 133 to which a platinum catalyst (7.8 mg) was applied as a solid catalyst, which is referred to as “GDE-Anode-1”.

### [Electrolytic Device (Part 1)]

A membrane electrode assembly (hereinafter, may be abbreviated as “MEA”) composed of the electrolyte film 102, the cathode catalyst layer 103 and the anode catalyst layer 113 was prepared. As an ion exchange membrane used for the electrolyte film 102, a Nafion 212 membrane (registered trademark, commercially available from Du Pont Inc.) (film thickness of 50 m, 5 cm×5 cm) was used. “GDE-Cathode-1” of the gas diffusion electrode 133 which is a cathode catalyst layer was disposed on one surface of the ion exchange membrane, “GDE-Anode-1” of the gas diffusion electrode 133 which is an anode catalyst layer was disposed on the other surface, and bonding by thermal compression was then performed under conditions of an upper and lower panel temperature of 132° C., a load of 5.4 kN, and a compression time of 240 seconds to prepare a membrane electrode assembly “MEA-1”.

On both surfaces of the obtained “MEA-1”, the stainless steel current collectors 104 and 114 with 25 circular holes of 2.5 mm in diameter were attached to the electrolysis tank together with a Teflon (registered trademark) sheet as a gasket 134, and the electrolytic device (Part 1) 100 shown in FIG. 1 was assembled.

### 2. Production Using Ammonia Electrolytic Device

Using the electrolytic device for ammonia production (Part 1) assembled as described above, ammonia was produced by electrolysis under the following conditions.
Temperature of device body: 25 to 28° C. (room temperature)
Power source device 101: the voltage and the current were measured using Versa STAT4 (commercially available from Princeton Applied Research, AMETEK, Inc.).
Cathode electrolytic solution tank 105: nitrogen was bubbled in the sulfuric acid aqueous solution (0.02 mol/L, 6 mL) at 10 mL/min.
Anode electrolytic solution tank 115: hydrogen gas was flowed at 5 mL/min.
Dilute sulfuric acid aqueous solution tank for ammonia collection 125: sulfuric acid aqueous solution (0.02 mol/L, 10 mL)
Electrolysis condition: constant potential electrolysis was performed at −2.3 V for 1 hour.

Ammonia was quantified using Thermo Scientific Dionex ion chromatography (IC) system, Dionex Integrion (commercially available from Thermo Fisher Scientific K.K.). The sulfuric acid aqueous solution in the dilute sulfuric acid aqueous solution tank for ammonia collection 125 and the sulfuric acid aqueous solution in the cathode electrolytic solution tank 105 were recovered, and the amount of ammonia was quantified to determine the amount of ammonia produced.

The amount of ammonia produced in this example was 1.21 (mol).

### Example 2

### 1. Preparation of Electrolytic Device for Ammonia Production

The cathode catalyst layer 103 was prepared as follows. A catalyst ink 2A used for the cathode 108 was an ink for applying the cathode solid catalyst of the present embodiment to the cathode catalyst layer 103. The catalyst ink 2A was prepared using a platinum catalyst supported on carbon black (platinum content: 46.5 wt %, product name “TEC10E50E”, commercially available from Tanaka Kikinzoku Kogyo K.K.) as a solid catalyst, 2-propanol (commercially available from Junsei Chemical Co., Ltd.) and a Nafion dispersion solution (product name “5% Nafion dispersion solution DE520 CS type”, commercially available from FUJIFILM Wako Pure Chemical Corporation) as an electrolyte. The carbon-supported platinum catalyst, the Nafion dispersion solution, and 2-propanol were added in that order to a glass vial bottle, and the dispersion solution was irradiated with ultrasonic waves using an ultrasonic cleaner ASU-6 (commercially available from As One Corporation) with an oscillation power set to High for 30 minutes to prepare the catalyst ink 2A. The proportion of Nafion (hereinafter abbreviated as an ionomer) in the catalyst ink 2A will be described. The catalyst ink 2A was prepared such that the proportion of ionomer (wt %) calculated from the formula was 28 wt %. Specifically, the amount of the carbon-supported platinum catalyst was 100 mg, the amount of the Nafion dispersion solution was 837 μL (the Nafion solid content in the dispersion solution was 38.9 mg), and the amount of 2-propanol was 2.5 mL.

The catalyst ink 2A was applied according to the following operation. Carbon paper (product name “TGP-H-060H”, commercially available from Toray Industries, Inc.) was attached to a fixture so that the surface to be applied could be set to a 6.8 cm×6.8 cm square, and an applicator was used for application. Application was performed using the entire amount of the prepared catalyst ink 2A, and the solvent and 2-propanol in the Nafion dispersion solution were dried to prepare the gas diffusion electrode 133 in which the amount of platinum per 1 cm² of the applied surface was 1 mg. Specifically, the gas diffusion electrode 133 was a 2.8×2.8 cm² square gas diffusion electrode 133 to which a platinum catalyst (7.8 mg) was applied as a solid catalyst, which is referred to as “GDE-Cathode-2A”.

Next, a catalyst ink 2B for applying the metal complex of the present embodiment to the cathode catalyst layer 103 was prepared. A solution in which rac-ethylenebis(4,5,6,7-tetrahydro-1-indenyl)zirconium dichloride (6.8 mg, 16 mol) as a metal complex was dissolved in 1-butyl-3-methylimidazolium bis(trifluoromethanesulfonyl)imide (2.4 mL) was used as the catalyst ink 2B. The catalyst ink 2B (20 L) was applied to “GDE-Cathode-2A” of the gas diffusion electrode 133 to prepare the cathode catalyst layer 103. Specifically, the gas diffusion electrode 133 which is the cathode catalyst layer 103 was a 2.8×2.8 cm² square gas diffusion electrode 133 to which a platinum catalyst (7.8 mg) as a solid catalyst and rac-ethylenebis(4,5,6,7-tetrahydro-1-indenyl)zirconium dichloride (0.13 mol) were applied, which is referred to as “GDE-Cathode-2”.

The anode catalyst layer 113 was prepared as follows. The catalyst ink 2A described for the cathode catalyst layer 103 was prepared by the same method and applied by the same method to prepare the gas diffusion electrode 133 which is the anode catalyst layer 113 containing Nafion as an electrolyte and a carbon-supported platinum catalyst as a solid catalyst. Specifically, the gas diffusion electrode 133 which is the anode catalyst layer 113 was a 2.8×2.8 cm² square gas diffusion electrode 133 to which a platinum catalyst (7.8 mg) was applied as a solid catalyst, which is referred to as “GDE-Anode-2”.

### [Electrolytic Device (Part 2)]

A membrane electrode assembly composed of the electrolyte film 102, the cathode catalyst layer 103 and the anode catalyst layer 113 was prepared as follows. As the ion exchange membrane used for the electrolyte film 102, a Nafion 212 membrane (registered trademark, commercially available from Du Pont Inc.) (film thickness of 50 m, 5 cm×5 cm) was used. “GDE-Cathode-2” of the gas diffusion electrode 133 which is a cathode catalyst layer was disposed on one surface of the ion exchange membrane, “GDE-Anode-2” of the gas diffusion electrode 133 which is an anode catalyst layer was disposed on the other surface and bonding by thermal compression was then performed under conditions of an upper and lower panel temperature of 132° C., a load of 5.4 kN, and a compression time of 240 seconds to prepare a membrane electrode assembly “MEA-2”.

The titanium separator 214 plated with platinum was attached to an anode side surface of the obtained “MEA-2”, the carbon separator 204 was attached to a cathode side surface together with a Teflon (registered trademark) sheet as the gasket 134, the current collectors 104 and 114 plated with gold were then attached from both sides in a sandwiched manner, and the electrolytic device (Part 2) 200 shown in FIG. 2 was assembled. The separator had the flow paths 135 and 136 through which a gas, an electrolytic solution, a reaction solution and the like flowed.

### 2. Production Using Ammonia Electrolytic Device

Using the electrolytic device for ammonia production (Part 2) assembled as described above, ammonia was produced by electrolysis under the following conditions.
Temperature of device body: 80° C.
Power source device 101: the voltage and the current were measured using Versa STAT4 (commercially available from Princeton Applied Research, AMETEK, Inc.).
Cathode catalyst layer 103: humidified nitrogen (relative humidity of 95%) was flowed at 10 mL/min.
Anode catalyst layer 113: humidified hydrogen (relative humidity of 95%) was flowed at 5 mL/min.
Dilute sulfuric acid aqueous solution tank for ammonia collection 125: sulfuric acid aqueous solution (0.02 mol/L, 10 mL)
Electrolysis condition: constant potential electrolysis was performed at −2.3 V for 1 hour.

A sulfuric acid aqueous solution (0.02 mol/L, 6 mL) was added to the sulfuric acid aqueous solution in the dilute sulfuric acid aqueous solution tank for ammonia collection 125 and the flow path for a gas, an electrolytic solution and a reaction solution on the cathode side 136 through the liquid transfer pump 303, the sulfuric acid aqueous solution was recovered in the electrolytic solution and reaction solution recovery tank 201 on the cathode side from the cathode through the pipe 121, and the amount of ammonia was quantified by the method described in Example 1 to determine the amount of ammonia produced.

The amount of ammonia produced in this example was 2.02 (mol).

### Comparative Example 1

The same electrolytic device (Part 1) as in Example 1 was prepared, and the same experiment operation as in Example 1 was performed except that hydrogen was not supplied to the anode electrolytic solution tank and the anode catalyst layer, and water (6 mL) was added. In the result of this example, the amount of ammonia produced was 0.32 (mol).

Comparing Comparative Example 1 with Experimental Example 1, when hydrogen molecules were provided by the means for supplying hydrogen gas at the anode, in the device of this example, the efficiency of ammonia production was able to be improved by about 4 times.

### Example 3

### 1. Preparation of Electrolytic Device for Ammonia Production

“GDE-Cathode-1” and “GDE-Anode-1”, which are the same gas diffusion electrode as in Example 1, were prepared.

### [Electrolytic Device (Part 3)]

An “MEA” composed of the electrolyte film 102, the cathode catalyst layer 103 and the anode catalyst layer 113 was prepared as follows. As the ion exchange membrane used for the electrolyte film 102, a Nafion 212 membrane (registered trademark, commercially available from Du Pont Inc.) (film thickness of 50 m, 5 cm×5 cm) was used. “GDE-Cathode-1” of the gas diffusion electrode 133 which is a cathode catalyst layer was disposed on one surface of the ion exchange membrane, “GDE-Anode-1” of the gas diffusion electrode 133 which is an anode catalyst layer was disposed on the other surface, and bonding by thermal compression was then performed under conditions of an upper and lower panel temperature of 132° C., a load of 5.4 kN, and a compression time of 240 seconds to prepare a membrane electrode assembly “MEA-1”.

On both surfaces of the obtained “MEA-1”, the stainless steel current collectors 104 and 114 with 25 circular holes of 2.5 mm in diameter were attached to the electrolysis tank together with a Teflon (registered trademark) sheet as the gasket 134, and the electrolytic device (Part 3) 300 shown in FIG. 3 was assembled.

### 2. Production Using Ammonia Electrolytic Device

Using the electrolytic device for ammonia production (Part 3) assembled as described above, ammonia was produced by electrolysis under the following conditions. The cocks and connections in the device were adjusted so that the gas flows during operation of the electrolytic device (Part 3) 300 were flows as indicated by arrows in FIG. 6.
Temperature of device body: 25 to 28° C. (room temperature)
Power source device 101: the voltage and the current were measured using Versa STAT4 (commercially available from Princeton Applied Research, AMETEK, Inc.).
Cathode electrolytic solution tank 105: nitrogen was bubbled in the sulfuric acid aqueous solution (0.02 mol/L, 6 mL) at 10 mL/min.
Anode electrolytic solution tank 115: hydrogen gas produced at the cathode was sent to the anode through the pipe 305. No anode electrolytic solution 116 was used.
Dilute sulfuric acid aqueous solution tank for ammonia collection 125: sulfuric acid aqueous solution (0.02 mol/L, 10 mL)
Electrolysis condition: constant potential electrolysis was performed at −2.0 V for 1 hour.

The amount of ammonia was quantified by the method described in Example 1. The amount of ammonia produced in this example was 0.94 (mol).

### Example 4

### 1. Preparation of Electrolytic Device for Ammonia Production

“GDE-Cathode-2” and “GDE-Anode-2”, which are the same gas diffusion electrode as in Example 2, were prepared.

### [Electrolytic Device (Part 4)]

A membrane electrode assembly composed of the electrolyte film 102, the cathode catalyst layer 103 and the anode catalyst layer 113 was prepared as follows. As the ion exchange membrane used for the electrolyte film 102, a Nafion 212 membrane (registered trademark, commercially available from Du Pont Inc.) (film thickness of 50 m, 5 cm×5 cm) was used. “GDE-Cathode-2” of the gas diffusion electrode 133 which is a cathode catalyst layer was disposed on one surface of the ion exchange membrane, “GDE-Anode-2” of the gas diffusion electrode 133 which is an anode catalyst layer was disposed on the other surface and bonding by thermal compression was then performed under conditions of an upper and lower panel temperature of 132° C., a load of 5.4 kN, and a compression time of 240 seconds to prepare a membrane electrode assembly “MEA-2”.

The titanium separator 214 plated with platinum was attached to an anode side surface of the obtained “MEA-2”, the carbon separator 204 was attached to a cathode side surface together with a Teflon (registered trademark) sheet as the gasket 134, the current collectors 104 and 114 plated with gold were then attached from both sides in a sandwiched manner, and the electrolytic device (Part 4) 400 shown in FIG. 4 was assembled. The separator had the flow paths 135 and 136 through which a gas, an electrolytic solution, a reaction solution and the like flowed.

### 2. Production Using Ammonia Electrolytic Device

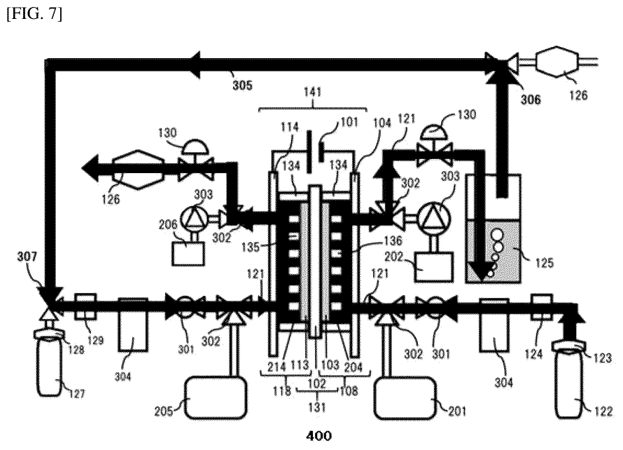

Using the electrolytic device for ammonia production (Part 4) assembled as described above, ammonia was produced by electrolysis under the following conditions. The cocks and connections in the device were adjusted so that the gas flows during operation of the electrolytic device (Part 4) 400 were flows as indicated by arrows in FIG. 7.
Temperature of device body: 80° C.
Power source device 101: the voltage and the current were measured using Versa STAT4 (commercially available from Princeton Applied Research, AMETEK, Inc.).
Cathode catalyst layer 103: humidified nitrogen (relative humidity of 95%) was flowed at 10 mL/min.
Anode catalyst layer 113: hydrogen gas produced at the cathode was sent to the anode through the pipe 305.
Dilute sulfuric acid aqueous solution tank for ammonia collection 125: sulfuric acid aqueous solution (0.02 mol/L, 10 mL)
Electrolysis condition: constant potential electrolysis was performed at −2.3 V for 1 hour.

The amount of ammonia was quantified by the method described in Example 2. The amount of ammonia produced in this example was 1.31 (mol).

### Comparative Example 2

The same electrolytic device (Part 3) as in Example 3 was prepared, and the same experiment operation as in Example 3 was performed except that hydrogen was not supplied to the anode electrolytic solution tank and the anode catalyst layer, and water (6 mL) was added. In the result of this example, the amount of ammonia produced was 0.27 (mol).

Comparing Comparative Example 2 with Example 3, when hydrogen molecules were provided by the means for sending hydrogen gas produced at the cathode to the anode, in the device of this example, the efficiency of ammonia production was able to be improved by about 3 times.

### Example 5

### 1. Preparation of Electrolytic Device for Ammonia Production

“GDE-Cathode-2A” and “GDE-Anode-2”, which are the same gas diffusion electrode as in Example 2, were prepared.

Next, a catalyst ink 5B for applying the metal complex of the present embodiment to the cathode catalyst layer 103 was prepared. A solution in which bis(cyclopentadienyl)titanium(IV) dichloride (4.0 mg, 16 mol) as a metal complex was dissolved in 1-butyl-3-methylimidazolium bis(trifluoromethanesulfonyl)imide(2.4 mL) was used as the catalyst ink 5B. The catalyst ink 5B (20 L) was applied to “GDE-Cathode-2A” of the gas diffusion electrode 133 to prepare the cathode catalyst layer 103. Specifically, the gas diffusion electrode 133, which is the cathode catalyst layer 103, was a 2.8×2.8 cm² square the gas diffusion electrode 133 to which a platinum catalyst (7.8 mg) as a solid catalyst and bis(cyclopentadienyl)titanium(IV) dichloride (0.13 mol) were applied, which is referred to as “GDE-Cathode-5”.

### [Electrolytic Device (Part 3)]

An “MEA” composed of the electrolyte film 102, the cathode catalyst layer 103 and the anode catalyst layer 113 was prepared as follows. As the ion exchange membrane used for the electrolyte film 102, a Nafion 212 membrane (registered trademark, commercially available from Du Pont Inc.) (film thickness of 50 m, 5 cm×5 cm) was used. “GDE-Cathode-5” of the gas diffusion electrode 133 which is a cathode catalyst layer was disposed on one surface of the ion exchange membrane, “GDE-Anode-2” of the gas diffusion electrode 133 which is an anode catalyst layer was disposed on the other surface, and bonding by thermal compression was then performed under conditions of an upper and lower panel temperature of 132° C., a load of 5.4 kN, and a compression time of 360 seconds to prepare a membrane electrode assembly “MEA-5”.

On both surfaces of the obtained “MEA-5”, the stainless steel current collectors 104 and 114 with 25 circular holes of 2.5 mm in diameter were attached to the electrolysis tank together with a Teflon (registered trademark) sheet as the gasket 134, and the electrolytic device (Part 3) 300 shown in FIG. 3 was assembled.

### 2. Production Using Ammonia Electrolytic Device

Using the electrolytic device for ammonia production (Part 3) assembled as described above, ammonia was produced by electrolysis under the following conditions. The cocks and connections in the device were adjusted so that the gas flows during operation of the electrolytic device (Part 3) 300 were flows as indicated by arrows in FIG. 6.
Temperature of device body: 25 to 28° C. (room temperature)
Power source device 101: the voltage and the current were measured using Versa STAT4 (commercially available from Princeton Applied Research, AMETEK, Inc.).
Cathode electrolytic solution tank 105: nitrogen was flowed with bubbling into the sulfuric acid aqueous solution (0.02 mol/L, 6 mL) at 10 mL/min.
Anode electrolytic solution tank 115: hydrogen gas produced at the cathode was sent to the anode through the pipe 305. For the anode electrolytic solution 116, a sulfuric acid aqueous solution (0.02 mol/L, 6 mL) was used, and hydrogen gas produced at the cathode was bubbled together with nitrogen.
Dilute sulfuric acid aqueous solution tank for ammonia collection 125: sulfuric acid aqueous solution (0.02 mol/L, 10 mL)
Electrolysis condition: constant potential electrolysis was performed at −2.3 V for 1 hour.

The amount of ammonia was quantified by the method described in Example 1. The amount of ammonia produced in this example was 1.43 (mol).

### Example 6

### 1. Preparation of Electrolytic Device for Ammonia Production

“GDE-Cathode-5”, which is the same gas diffusion electrode as in Example 5 and “GDE-Anode-2”, which is the same gas diffusion electrode as in Example 2, were prepared.

### [Electrolytic Device (Part 5)]

A membrane electrode assembly composed of the electrolyte film 102, the cathode catalyst layer 103 and the anode catalyst layer 113 was prepared as follows. As the ion exchange membrane used for the electrolyte film 102, a Nafion 212 membrane (registered trademark, commercially available from Du Pont Inc.) (film thickness of 50 m, 5 cm×5 cm) was used. “GDE-Cathode-5” of the gas diffusion electrode 133 which is a cathode catalyst layer was disposed on one surface of the ion exchange membrane, “GDE-Anode-2” of the gas diffusion electrode 133 which is an anode catalyst layer was disposed on the other surface, and bonding by thermal compression was then performed under conditions of an upper and lower panel temperature of 132° C., a load of 5.4 kN, and a compression time of 360 seconds to prepare a membrane electrode assembly “MEA-6”.

On both surfaces of the obtained “MEA-6”, the stainless steel current collectors 104 and 114 with 25 circular holes of 2.5 mm in diameter were attached to the electrolysis tank together with a Teflon (registered trademark) sheet as the gasket 134, and the electrolytic device (Part 5) 500 shown in FIG. 5 was assembled.

### 2. Production Using Ammonia Electrolytic Device

Using the electrolytic device for ammonia production (Part 5) assembled as described above, ammonia was produced by electrolysis under the following conditions. In addition to an operation of flowing a gas when the electrolytic device (Part 5) 500 operated, an operation of closing the two-way cock 308 on the anode side and the cathode side, introducing the reaction gas and the electrolytic solution and then closing the two-way cock 309 was repeated.
Temperature of device body: 25 to 28° C. (room temperature)
Power source device 101: the voltage and the current were measured using Versa STAT4 (commercially available from Princeton Applied Research, AMETEK, Inc.).
Cathode electrolytic solution tank 105: an operation of flowing nitrogen with bubbling into the sulfuric acid aqueous solution (0.02 mol/L, 6 mL) at 10 mL/min for 8 minutes, and an operation of closing the two-way cock 308 for 30 seconds, then closing the two-way cock 309, and waiting for 1 minute and 30 seconds, were performed. Then, bubbling of nitrogen was performed again. The above sequence of operations was repeated six times within one hour.
Anode electrolytic solution tank 115: an operation of flowing hydrogen gas at 3 m/min for 8 minutes, and an operation of closing the two-way cock 308 for 30 seconds, then closing the two-way cock 309, and waiting for 1 minute and 30 seconds, were performed. Then, flowing of hydrogen was performed again. The above sequence of operations was repeated six times within one hour.
Electrolysis condition: constant potential electrolysis was performed at −2.3 V for 1 hour.

The amount of ammonia was quantified by the method described in Example 1. The amount of ammonia produced in this example was 1.95 (mol).

### Example 7

### 1. Preparation of Electrolytic Device for Ammonia Production

“GDE-Cathode-5”, which is the same gas diffusion electrode as in Example 5 and “GDE-Anode-2”, which is the same gas diffusion electrode as in Example 2, were prepared.

### [Electrolytic Device (Part 4)]

A membrane electrode assembly composed of the electrolyte film 102, the cathode catalyst layer 103 and the anode catalyst layer 113 was prepared as follows. As the ion exchange membrane used for the electrolyte film 102, a Nafion 212 membrane (registered trademark, commercially available from Du Pont Inc.) (film thickness of 50 m, 5 cm×5 cm) was used. “GDE-Cathode-5” of the gas diffusion electrode 133 which is a cathode catalyst layer was disposed on one surface of the ion exchange membrane, “GDE-Anode-2” of the gas diffusion electrode 133 which is an anode catalyst layer was disposed on the other surface, and bonding by thermal compression was then performed under conditions of an upper and lower panel temperature of 132° C., a load of 5.4 kN, and a compression time of 240 seconds to prepare a membrane electrode assembly “MEA-7”.

The titanium separator 214 plated with platinum was attached to an anode side surface of the obtained “MEA-7”, the carbon separator 204 was attached to a cathode side surface together with a Teflon (registered trademark) sheet as the gasket 134, the current collectors 104 and 114 plated with gold were then attached from both sides in a sandwiched manner, and the electrolytic device (Part 4) 400 shown in FIG. 4 was assembled. The separator had the flow paths 135 and 136 through which a gas, an electrolytic solution, a reaction solution and the like flowed.

### 2. Production Using Ammonia Electrolytic Device

Using the electrolytic device for ammonia production (Part 4) assembled as described above, ammonia was produced by electrolysis under the following conditions. In parallel with an operation of adjusting cocks and connections in the device so that the gas flows during operation of the electrolytic device (Part 4) 400 were flows as indicated by arrows in FIG. 7, an operation of closing the three-way cock 302 of the electrolytic device (Part 4) 400 (FIG. 4) after the reaction gas and the electrolytic solution were introduced into the anode side and cathode side flow paths and pressurizing the cathode catalyst layer and the anode catalyst layer with the reaction gas and the electrolytic solution was repeated.
Temperature of device body: 80° C.
Power source device 101: the voltage and the current were measured using Versa STAT4 (commercially available from Princeton Applied Research, AMETEK, Inc.).
Cathode catalyst layer 103: 10 mL/min, an operation of flowing humidified nitrogen (relative humidity of 95%) for 8 minutes, and an operation of closing two three-way cocks 302 for the cathode catalyst layer, performing pressurization, and waiting for 2 minutes, were performed. Then, flowing of humidified nitrogen was performed again. The above sequence of operations was repeated six times within one hour.
Anode catalyst layer 113: an operation of sending hydrogen gas produced at the cathode to the anode through the pipe 305 for 8 minutes, and an operation of closing two three-way cocks 302 for the anode catalyst layer, performing pressurization, and waiting for 2 minutes, were performed. Then, sending of hydrogen gas produced at the cathode was performed again. The above sequence of operations was repeated six times within one hour.
Dilute sulfuric acid aqueous solution tank for ammonia collection 125: sulfuric acid aqueous solution (0.02 mol/L, 10 mL)
Electrolysis condition: constant potential electrolysis was performed at −2.3 V for 1 hour.

The amount of ammonia was quantified by the method described in Example 2. The amount of ammonia produced in this example was 1.57 (mol).

### Example 8

### 1. Preparation of Electrolytic Device for Ammonia Production

The same electrolytic ammonia production device as in Example 7 was prepared.

### 2. Production Using Ammonia Electrolytic Device

Using the same electrolytic ammonia production device as in Example 7, ammonia was produced by electrolysis under the following conditions. In parallel with an operation of adjusting cocks and connections in the device so that the gas flows during operation of the electrolytic device (Part 4) 400 were flows as indicated by arrows in FIG. 7, an operation of closing the three-way cock 302 of the electrolytic device (Part 4) 400 (FIG. 4) after the reaction gas and the electrolytic solution were introduced into the anode side and cathode side flow paths and pressurizing the cathode catalyst layer and the anode catalyst layer with the reaction gas and the electrolytic solution was repeated.
Temperature of device body: 80° C.
Power source device 101: the voltage and the current were measured using Versa STAT4 (commercially available from Princeton Applied Research, AMETEK, Inc.).
Cathode catalyst layer 103: 50 mL/min, an operation of flowing humidified nitrogen (relative humidity of 95%) for 9 minutes and 30 seconds, and an operation of closing two three-way cocks 302 for the cathode catalyst layer, performing pressurization, and waiting for 30 seconds, were performed. Then, flowing of humidified nitrogen was performed again. The above sequence of operations was repeated six times within one hour.
Anode catalyst layer 113: an operation of sending hydrogen gas produced at the cathode to the anode through the pipe 305 for 9 minutes and 30 seconds, and an operation of closing two three-way cocks 302 for the anode catalyst layer, performing pressurization, and waiting for 30 seconds, were performed. Then, sending of hydrogen gas produced at the cathode was performed again. The above sequence of operations was repeated six times within one hour.
Dilute sulfuric acid aqueous solution tank for ammonia collection 125: sulfuric acid aqueous solution (0.02 mol/L, 10 mL)
Electrolysis condition: constant potential electrolysis was performed at −2.3 V for 1 hour.

The amount of ammonia was quantified by the method described in Example 2. The amount of ammonia produced in this example was 1.88 (mol).

### INDUSTRIAL APPLICABILITY

The present invention can be used in the ammonia production method.

### DESCRIPTION OF THE REFERENCE NUMERALS

100 Ammonia electrolytic device (Part 1)
200 Ammonia electrolytic device (Part 2)
300 Ammonia electrolytic device (Part 3)
400 Ammonia electrolytic device (Part 4)
500 Ammonia electrolytic device (Part 5)
101 Power source device
102 Electrolyte film
103 Cathode catalyst layer (catalyst layer for producing ammonia)
104 Cathode current collector
105 Cathode electrolytic solution tank
106 Cathode electrolytic solution
108 Cathode (cathode catalyst layer and cathode current collector)
113 Anode catalyst layer
114 Anode current collector
115 Anode electrolytic solution tank
116 Anode electrolytic solution
118 Anode (anode catalyst layer or anode current collector)
121 Pipe
122 Nitrogen cylinder
123 Nitrogen cylinder regulator
124 Nitrogen gas mass-flow controller
125 Dilute sulfuric acid aqueous solution tank for ammonia collection
126 Draft device
127 Hydrogen cylinder
128 Hydrogen cylinder regulator
129 Hydrogen gas mass-flow controller
130 Backpressure valve
131 Membrane electrode assembly
132 Cathode membrane electrode assembly
133 Gas diffusion electrode
134 Gasket
135 Flow path for gas, electrolytic solution and reaction solution on anode side
136 Flow path for gas, electrolytic solution and reaction solution on cathode side
141 Electrolysis cell
201 Electrolytic solution and reaction solution recovery tank on cathode side
202 Electrolytic solution and reaction solution storage tank on cathode side
204 Separator on cathode side
205 Electrolytic solution and reaction solution recovery tank on anode side
206 Electrolytic solution and reaction solution storage tank on anode side
214 Separator on anode side
301 Two-way cock
302 Three-way cock
303 Liquid transfer pump
304 Gas humidification device
305 Pipe (pipe for using by-produced hydrogen (by-product at cathode) at anode)
306 Three-way cock
307 Three-way cock
308 Two-way cock
309 Two-way cock

1. An ammonia production method using nitrogen molecules as a raw material,
comprising:
in a production device that performs an electrolysis reaction, in the presence of a metal complex and a solid catalyst in a cathode,
providing electrons from a power source, protons from a proton source, and nitrogen molecules from a means for supplying nitrogen gas; and
providing hydrogen molecules from a means for supplying hydrogen gas at an anode.

2. The ammonia production method according to claim 1,
wherein the means for supplying hydrogen gas at the anode includes a means for sending hydrogen gas produced at the cathode to the anode.

3. The ammonia production method according to claim 1,
wherein the metal complex is a compound that is a nitrogen complex in which nitrogen molecules are coordinated to a metal in the center of the catalyst,
the solid catalyst is a metal catalyst, a transition metal catalyst, a noble metal catalyst, an alloy catalyst, an oxide catalyst, or a combination thereof, and
the proton source is at least one selected from the group consisting of an electrolyte film, an electrolytic solution, a catalyst layer, and an electrolyte in the catalyst layer.

4. The ammonia production method according to claim 1,
wherein the metal complex is a metallocene compound or a half-metallocene compound.

5. The ammonia production method according to claim 1,
wherein the metal complex is bis(cyclopentadienyl)titanium dichloride, bis(cyclopentadienyl)zirconium dichloride, rac-dimethylsilylbis(1-indenyl)zirconium dichloride, or rac-ethylenebis(4,5,6,7-tetrahydro-1-indenyl)zirconium dichloride.

6. The ammonia production method according to claim 1,
wherein the solid catalyst contains platinum, gold, palladium, or zinc oxide.

7. An ammonia production device that produces ammonia from nitrogen molecules according to an electrolysis reaction and has a configuration including a cathode in which a cathode catalyst layer is bonded to one side of an electrolyte film and a cathode current collector is disposed on an outside of the cathode catalyst layer and an anode in which an anode catalyst layer is bonded to another side of the electrolyte film and an anode current collector is disposed on an outside of the anode catalyst layer, the cathode including the cathode catalyst layer and the cathode current collector, the anode including the anode catalyst layer and the anode current collector, the cathode including a cathode electrolytic solution tank with which a solid-liquid-gas is able to come into contact, and the anode including an anode electrolytic solution tank with which a solid-liquid-gas is able to come into contact, the device comprising:
a means for sending hydrogen gas to the anode;
a power source for supplying electrons to the cathode;
a proton source for supplying protons to the cathode; and
a means for supplying nitrogen gas to the cathode electrolytic solution tank, a cathode electrolytic solution, or the cathode.

8. The ammonia production device according to claim 7,
wherein the means for sending hydrogen gas to the anode includes a means for sending hydrogen gas produced at the cathode to the anode.

9. An ammonia production device that produces ammonia from nitrogen molecules according to an electrolysis reaction and has a configuration including a cathode in which a cathode catalyst layer is bonded to one side of an electrolyte film and a cathode current collector is disposed on an outside of the cathode catalyst layer and an anode in which an anode catalyst layer is bonded to another side of the electrolyte film and an anode current collector is disposed on an outside of the anode catalyst layer, the cathode including the cathode catalyst layer and the cathode current collector, the anode including the anode catalyst layer and the anode current collector, the cathode including a flow path with which a solid-liquid-gas is able to come into contact, and the anode including a flow path with which a solid-liquid-gas is able to come into contact, the device comprising:
a means for sending hydrogen gas to the anode;
a power source for supplying electrons to the cathode;
a proton source for supplying protons to the cathode; and
a means for supplying nitrogen gas to a cathode electrolytic solution tank, a cathode electrolytic solution, or the cathode.

10. The ammonia production device according to claim 9,
wherein the means for sending hydrogen gas to the anode includes a means for sending hydrogen gas produced at the cathode to the anode.
